(19) United States
(12) Patent Application Publication
(10) Pub. No.: US 2026/0329129 A1
(43) Pub. Date: Oct. 22, 2026

(54) LIGHT SOURCE DEVICE, METHOD FOR MANUFACTURING SAME, AND DISPLAY APPARATUS COMPRISING LIGHT SOURCE DEVICE

(71) Applicant: SAMSUNG ELECTRONICS CO., LTD., Suwon-si (KR)

(72) Inventors: Hyungsuk KIM, Suwon-si (KR); Taeyeon KIM, Suwon-si (KR); Hyukjun JANG, Suwon-si (KR); Chunsoon PARK, Suwon-si (KR); Dukjin JEON, Suwon-si (KR)

(73) Assignee: SAMSUNG ELECTRONICS CO., LTD., Suwon-si (KR)

(21) Appl. No.: 19/692,761

(22) Filed: May 29, 2026

Related U.S. Application Data
(63) Continuation of application No. PCT/KR2024/096320, filed on Oct. 11, 2024.

(30) Foreign Application Priority Data
Nov. 30, 2023 (KR) 10-2023-0170882

(51) Int. Cl. G02F 1/13357; B23K 1/00; B23K 101/36

(52) U.S. Cl. CPC G02F 1/133603; B23K 1/0016; B23K 2101/36

(57) ABSTRACT

There is provided a method for manufacturing a light source device including a first light source substrate and a second light source substrate, the method including: forming, in a base substrate, the first light source substrate including a first substrate body, extending in a first direction, and a first substrate bar extending from the first substrate body in a second direction; forming, in the base substrate, the second light source substrate including a second substrate body, extending in the first direction, and a second substrate bar extending from the second substrate body in a third direction opposite to the second direction and disposed alternately with the first substrate bar; forming bridges connecting the first light source substrate and the second light source substrate; disposing, on the base substrate, a mask pattern including an opening; disposing a solder on the mask pattern; and introducing the solder into the opening.

### CROSS-REFERENCE TO RELATED APPLICATIONS

This application is a continuation of International Application No. PCT/KR2024/096320, filed on Oct. 11, 2024, which is based on and claims priority to Korean Patent Application No. 10-2023-0170882, filed on Nov. 30, 2023, in the Korean Intellectual Property Office, the disclosures of which are incorporated by reference herein in their entireties.

### BACKGROUND

### 1. Field

The present disclosure relates to a light source device, a method for manufacturing the same, and a display apparatus including the light source device.

### 2. Description of Related Art

A display apparatus is a kind of an output apparatus that converts obtained or stored electrical information into visual information and displays the visual information to a user, and the display apparatus is used in various fields, such as home or workplace.

The display apparatus includes a monitor apparatus connected to a personal computer or a server computer, a portable computer device, a navigation terminal device, a general television apparatus, an Internet Protocol television (IPTV), a portable terminal device, such as a smart phone, a tablet PC, a personal digital assistant (PDA) or a cellular phone, various display apparatuses used to reproduce images, such as advertisements or movies in an industrial field, or various kinds of audio/video systems.

The display apparatus includes a light source module to convert electrical information into visual information, and the light source module includes a plurality of light sources to independently emit light.

Each of the plurality of light sources includes a light emitting diode (LED) or an organic light emitting diode (OLED). For example, the LED or the OLED may be mounted on a circuit board or substrate.

### SUMMARY

The present disclosure is directed to providing a light source device having a reduced defect rate, a method for manufacturing the same, and a display apparatus including the light source device.

Additional aspects of the disclosure will be set forth in part in the description which follows and, in part, will be obvious from the description, or may be learned by practice of the disclosure.

There is provided a method for manufacturing a light source device including a first light source substrate and a second light source substrate, the method including: forming, in a base substrate, the first light source substrate including a first substrate body, extending in a first direction, and a first substrate bar extending from the first substrate body in a second direction; forming, in the base substrate, the second light source substrate including a second substrate body, extending in the first direction, and a second substrate bar extending from the second substrate body in a third direction opposite to the second direction and disposed alternately with the first substrate bar; forming bridges connecting the first light source substrate and the second light source substrate; disposing, on the base substrate, a mask pattern including an opening; disposing a solder on the mask pattern; and introducing the solder into the opening.

The second substrate body of the second light source substrate and one end of the first substrate bar of the first light source substrate in the second direction may be connected by the plurality of bridges.

The pressing of the solder on the mask pattern may include moving a pressing member in the second direction and from the first substrate body toward the second substrate body.

The first substrate bar may include a plurality of first substrate bars, the second substrate bar may include a plurality of second substrate bars arranged alternately with the plurality of first substrate bars, and each of the plurality of first substrate bars and each of the plurality of second substrate bars are connected by the plurality of bridges.

The method may further include forming guide holes in the plurality of bridges.

The plurality of bridges provided between the first substrate body and the second substrate bar may include a first bridge, and, of the guide holes, a plurality of first guide holes may be arranged, in the first bridge, on the one end of the first substrate body in the second direction and on the one end of the second substrate bar in the third direction.

The plurality of bridges may connect the second substrate body of the second light source substrate and the one end of the first substrate bar of the first light source substrate in the second direction, the plurality of bridges provided between the second substrate body and the first substrate bar further comprise a second bridge, and, of the guide holes, a plurality of second guide holes are arranged, in the second bridge, on the one end of the second substrate body in the third direction and on the one end of the first substrate bar in the second direction.

The plurality of bridges provided between the first substrate bar and the second substrate bar further may include a third bridge, and, of the guide holes, a plurality of third guide holes may be arranged, in the third bridge, on the one end of the first substrate bar in the first direction and on the one end of the second substrate bar in a fourth direction opposite to the first direction.

Each of the plurality of first guide holes, the plurality of second guide holes, and the plurality of third guide holes may have a diameter of 0.1 to 0.3 mm.

The first substrate bar may include: a first central extending portion extended in the second direction; a first protrusion protruded in a fourth direction opposite to the first direction and from the first central extending portion; and a second protrusion protruded in the first direction from the first central extending portion, and the second substrate bar may include: a second central extending portion extended in the third direction; a third protrusion protruded in the fourth direction from the second central extending portion; and a fourth protrusion protruded in the first direction from the second central extending portion.

The first protrusion of the first substrate bar may include a first plurality of first protrusions, the second protrusion of the first substrate bar may include a first plurality of second protrusions, the first substrate bar further may include: a plurality of first recess portions each arranged between a first pair of adjacent first protrusions among the first plurality of first protrusions; and a plurality of second recess portions each arranged between a first pair of adjacent second protrusions among the first plurality of second protrusions, the first protrusion of the second substrate bar may include a second plurality of first protrusions, the second protrusion of the second substrate bar may include a second plurality of second protrusions, the second substrate bar further may include: a plurality of first recess portions each arranged between a second pair of adjacent first protrusions among the second plurality of first protrusions; and a plurality of second recess portions each arranged between a second pair of adjacent second protrusions among the second plurality of second protrusions.

The method may further include mounting a light source on any of the first protrusion, the second protrusion, the third protrusion, and the fourth protrusion.

### BRIEF DESCRIPTION OF THE DRAWINGS

FIG. 1 is a perspective view of a display apparatus according to an embodiment of the present disclosure.

FIG. 2 is an exploded view of the display apparatus according to an embodiment of the present disclosure.

FIG. 3 is a cross-sectional view of a display panel of the display apparatus according to an embodiment of the present disclosure.

FIG. 4 is an enlarged view of a light source device of the display apparatus according to an embodiment of the present disclosure.

FIG. 5 is a view illustrating a light source substrate and a bottom chassis of the display apparatus according to an embodiment of the present disclosure.

FIG. 6 is an enlarged view of the display apparatus according to an embodiment of the present disclosure.

FIG. 7 is an enlarged view of a portion of the light source substrate and the bottom chassis of the display apparatus according to an embodiment of the present disclosure.

FIG. 8 is an enlarged view of a portion of the light source substrate of the display apparatus according to an embodiment of the present disclosure.

FIG. 9 is a flowchart of a method for manufacturing the light source device of the display apparatus according to an embodiment of the present disclosure.

FIG. 10 is a schematic view illustrating a manufacturing process of the light source device in the display apparatus according to an embodiment of the present disclosure.

FIG. 11 is a schematic view illustrating the manufacturing process of the light source device in the display apparatus according to an embodiment of the present disclosure.

FIG. 12 is a schematic view illustrating the manufacturing process of the light source device in the display apparatus according to an embodiment of the present disclosure.

FIG. 13 is a schematic view illustrating the manufacturing process of the light source device in the display apparatus according to an embodiment of the present disclosure.

FIG. 14 is a schematic view illustrating the manufacturing process of the light source device in the display apparatus according to an embodiment of the present disclosure.

FIG. 15 is a schematic view illustrating the manufacturing process of the light source device in the display apparatus according to an embodiment of the present disclosure.

FIG. 16 is a schematic view illustrating the manufacturing process of the light source device in the display apparatus according to an embodiment of the present disclosure.

FIG. 17 is a schematic view illustrating the manufacturing process of the light source device in the display apparatus according to an embodiment of the present disclosure.

FIG. 18 is an enlarged view of a base substrate in the display apparatus according to an embodiment of the present disclosure.

FIG. 19 is an enlarged view of the base substrate in the display apparatus according to an embodiment of the present disclosure.

FIG. 20 is an enlarged view of the base substrate in the display apparatus according to an embodiment of the present disclosure.

FIG. 21 is a schematic view illustrating the manufacturing process of the light source device in the display apparatus according to an embodiment of the present disclosure.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In this disclosure, the meaning of “identical” may include things being similar in properties to each other or are similar within a certain range. In addition, the meaning “identical” refers to “substantially identical”. It should be understood that the meaning of “substantially identical” refers to a value that falls within an error range in manufacturing or a value having a difference within a range that does not have significance with respect to a reference value.

In the following description, terms such as “unit”, “part”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

In the following detailed description, the terms of “front”, “rear”, “left”, “right”, and the like may be defined by the drawings, but the shape and the location of the component is not limited by the term.

In addition, the terms “first direction,” “second direction,” and “third direction” used in the following description are defined based on the drawings, and the shape and position of each component are not limited by these terms. For example, although the first direction is described as indicating a horizontal direction, this may be an up and down direction or a front and rear direction. In addition, although the second direction and the third direction are described as upward and/or downward directions that are perpendicular to and opposite to the first direction, this may be a left and right direction or a front and rear direction.

Hereinafter exemplary embodiments of the present disclosure will be described in detail with reference to the accompanying drawings.

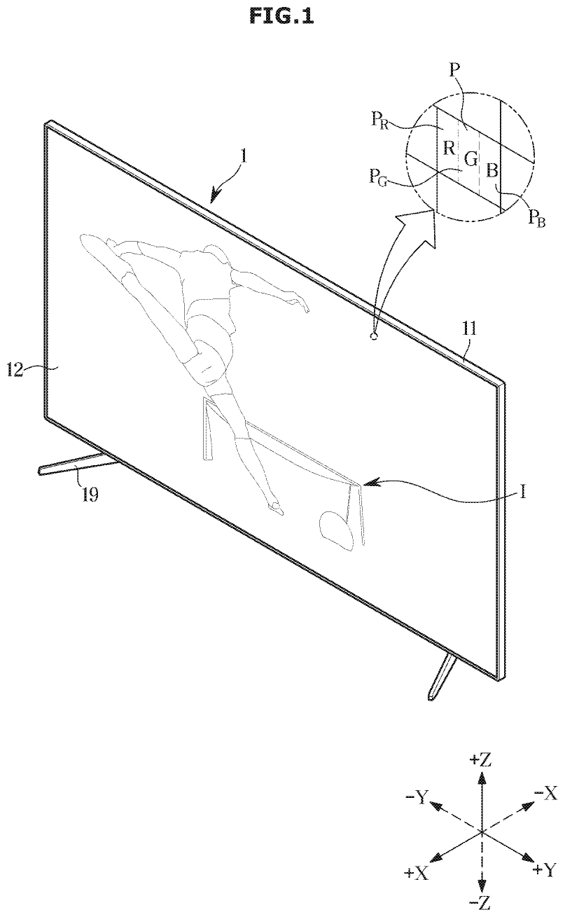

FIG. 1 is a perspective view of a display apparatus according to an embodiment of the present disclosure.

Referring to FIG. 1, a display apparatus 1 according to an embodiment of the present disclosure is a device that processes an image signal received from an outside and visually displays the processed image. Hereinafter a case in which the display apparatus 1 is a television is exemplified, but the present disclosure is not limited thereto. For example, the display apparatus 1 may be implemented in various forms, such as a monitor, a portable multimedia device, and a portable communication device, which are a type of computer output device, and the display apparatus 1 is not limited in the type thereof as long as the display apparatus is configured to visually display an image.

The display apparatus 1 may be a large format display (LFD) installed outdoors, such as a roof of a building or a bus stop. The outdoor is not limited to the outside of a building, and thus the display apparatus 1 according to an embodiment may be installed in any places as long as the display apparatus is accessed by a large number of people, even indoors, such as subway stations, shopping malls, movie theaters, companies, and stores.

FIG. 1 illustrates a flat display apparatus with a flat screen as an example of the display apparatus 1, but the present disclosure is not limited thereto. Therefore, the display apparatus according to the present disclosure may be applied to a curved display apparatus or a bendable or flexible display apparatus in which a flat state and a curved state are variable. Further, a configuration of the present disclosure may be applied to display apparatus of various shapes regardless of a screen size or ratio of the display apparatus.

The display apparatus 1 may receive content data including video signals and audio signals from various content sources and output video and audio corresponding to the video signals and the audio signals. For example, the display apparatus 1 may receive content data through a broadcast reception antenna or cable, receive content data from a content playback device, or receive content data from a content providing server of a content provider.

The display apparatus 1 may display an image corresponding to video data and output sound corresponding to audio data. For example, the display apparatus 1 may restore a plurality of image frames included in video data and continuously display the plurality of image frames. Further, the display apparatus 1 may restore an audio signal included in the audio data and continuously output sound according to the audio signal

The display apparatus 1 according to an embodiment may include a main body 11, and a screen 12 provided to display an image I.

The display apparatus 1 may be installed on an indoor or outdoor floor or furniture in a standing manner, or may be installed on a wall or inside a wall in a wall-mounted manner. For example, the display apparatus 1 may include a support leg 19 provided in a lower portion of the main body 11 to be installed on the indoor or outdoor floor or furniture in the standing manner.

The main body 11 may form an appearance of the display apparatus 1. A component configured to allow the display apparatus 1 to display the image I and to perform various functions may be provided in the main body 11.

The display apparatus 1 may be configured to display the image I. Particularly, the screen 12 may be formed on a front surface of the main body 11, and the display apparatus 1 may display the image I on the screen 12. For example, the screen 12 may display a still image or a moving image. Further, the screen 12 may display a two-dimensional plane image or a three-dimensional image using binocular parallax of the user.

A plurality of pixels P may be formed on the screen 12. The image I displayed on the screen 12 may be formed by a combination of the lights emitted from the plurality of pixels P. For example, the image I may be formed on the screen 12 by combining light emitted from the plurality of pixels P as a mosaic.

Each of the plurality of pixels P may emit different brightness and different color of light. Particularly, the plurality of pixels P may include sub-pixels P_{R}, P_{G}, and P_{B}, respectively, and the sub-pixels P_{R}, P_{G}, and P_{B} may include a red sub-pixel P_{R} emitting red light, a green sub-pixel P_{G} emitting green light, and a blue sub-pixel P_{B} emitting blue light. For example, the red light may represent a light beam having a wavelength of approximately 620 nm (nanometers, one billionth of a meter) to 750 nm, the green light may represent a light beam having a wavelength of approximately 495 nm to 570 nm, and the blue light may represent a light beam having a wavelength of approximately 450 nm to 495 nm.

By combining the red light of the red sub-pixel P_{R}, the green light of the green sub-pixel P_{G} and the blue light of the blue sub-pixel P_{B}, each of the plurality of pixels P may emit different brightness and different color of light.

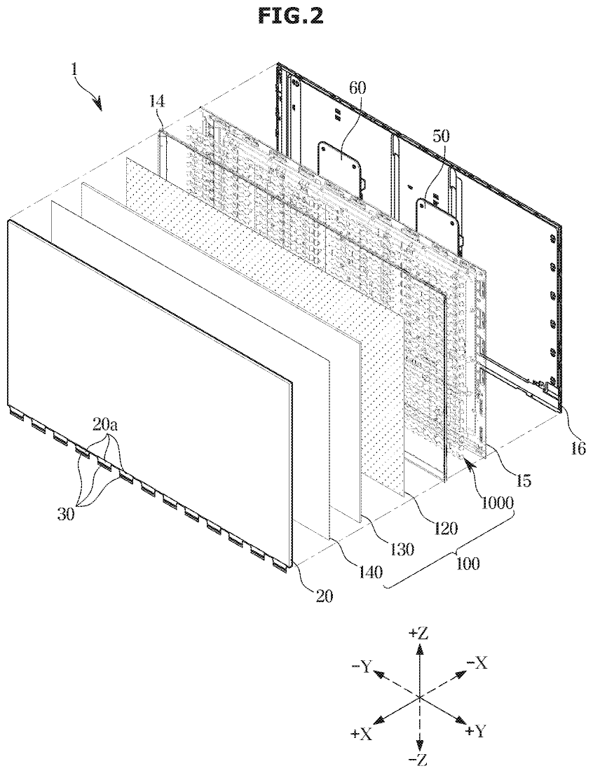

FIG. 2 is an exploded view of the display apparatus according to an embodiment of the present disclosure.

Referring to FIG. 2, various components for generating an image I on the screen 12 may be disposed inside the main body 11 of the display apparatus 1 according to an embodiment of the present disclosure. The main body 11 may include a middle mold 14, a bottom chassis 15, and/or a rear cover 16.

For example, the display apparatus 1 may include a display panel 20. The display panel 20 may be disposed on the main body 11. The display panel 20 may form a front portion of the display apparatus 1. The display panel 20 may be provided to display the image I. For example, the screen 12 may be formed on a front surface of the display panel 20.

For example, the display panel 20 may have a substantially rectangular shape. Particularly, the display panel 20 may have a shape in which a length of the horizontal side and a length of the vertical side are different from each other. That is, the display panel 20 may be provided to have a long side and a short side. The display panel 20 may be provided in a rectangular plate shape. However, the present disclosure is not limited thereto, and the display panel 20 may be provided in the shape of a square plate in which the lengths of the long and short sides are approximately equal.

The display panel 20 may be provided in various sizes. A ratio between the long side and the short side of the display panel 20 is not limited to general cases such as 16:9 and 4:3, but may be provided at any ratio.

In the display apparatus 1 according to an embodiment of the present disclosure, the display panel 20 may be composed of a non-self luminous display such as a liquid crystal display (LCD).

A cable 20a configured to transmit image data to the display panel 20, and a display driver integrated circuit (DDI) (hereinafter referred to as ‘driver IC’) 30 configured to process digital image data and output an analog image signal may be provided at one side of the display panel 20.

The cable 20a may electrically connect a control assembly 50/a power assembly 60 to the driver IC 30, and may also electrically connect the driver IC 30 to the display panel 20. The cable 20a may include a flexible flat cable or a film cable that is bendable.

The driver IC 30 may receive image data and power from the control assembly 50/the power assembly 60 through the cable 20a. The driver IC 30 may transmit the image data and driving current to the display panel 20 through the cable 20a.

In addition, the cable 20a and the driver IC 30 may be integrally implemented as a film cable, a chip on film (COF), or a tape carrier package (TCP). In other words, the driver IC 30 may be arranged on the cable 20b. However, the present disclosure is not limited thereto, and the driver IC 30 may be arranged on the display panel 20.

The display apparatus 1 may include a backlight unit 100 configured to emit light toward the display panel 20. The backlight unit 100 may be disposed in the main body 11. The backlight unit 100 may be arranged at the rear of the display panel 20 to emit light toward the front where the display panel 20 is located. The display panel 20 may block or transmit light emitted from the backlight unit 100. The backlight unit 100 may correspond to a light source device 100.

The backlight unit 100 may include a point light source configured to emit monochromatic light or white light. The backlight unit 100 may refract, reflect, and scatter light in order to convert light, which is emitted from the point light source, into uniform surface light. The backlight unit 100 may refract, reflect, and scatter light emitted from the point light source, thereby emitting uniform surface light toward the front side.

The backlight unit 100 may include a light source module 1000. The light source module 1000 may generate and emit light. For example, the light source module 1000 may be configured to emit monochromatic light or white light.

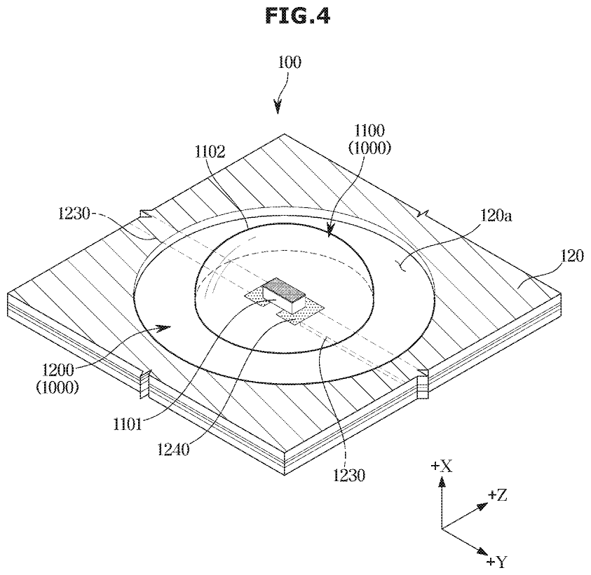

The light source module 1000 may include a plurality of light sources 1100 configured to emit light, and a light source substrate 1200 on which the plurality of light sources 1100 is mounted (e.g., refer to FIG. 4, and the like).

The backlight unit 100 may include a reflective sheet 120 provided to reflect light. The reflective sheet 120 may reflect light forward or in a direction close to the front. For example, the reflective sheet 120 may be attached to a front surface of the light source module 1000. The reflective sheet 120 may be attached to a front surface of the light source substrate 1200.

For example, in front of the reflective sheet 120, the light source module 1000 (particularly, the light source 1100 of the light source module 1000, refer to FIG. 4) may emit light in various directions. The light emitted from the light source module 1000 may not only be emitted toward a diffuser plate 130, which will be described later, but may also be emitted toward the reflective sheet 120. The reflective sheet 120 may reflect the light, which is emitted toward the reflective sheet 120, toward the diffuser plate 130.

Further, while the light emitted from the light source module 1000 passes through various objects such as the diffuser plate 130 and an optical sheet 140, a portion of the light may be reflected from a surface of the diffuser plate 130 and the optical sheet 140. The reflective sheet 120 may reflect the light, which is reflected by the above-mentioned reason, forward again.

The backlight unit 100 may include the diffuser plate 130 provided to uniformly diffuse light. The diffuser plate 130 may be provided in front of the light source module 1000 and the reflective sheet 120. The diffuser plate 130 may evenly disperse the light emitted from the light source module 1000 and then emit the light forward.

The backlight unit 100 may include the optical sheet 140 provided to further improve the luminance and uniformity of the luminance of the emitted light. The optical sheet 140 may be provided to refract and scatter light emitted from the front of the diffuser plate 130. For example, the optical sheet 140 may include various types of sheets, such as a diffusion sheet, a prism sheet, a reflective polarizing sheet, and a quantum dot sheet.

The diffuser plate 130 and the optical sheet 140 may correspond to an optical member.

The display apparatus 1 may include the control assembly 50 configured to control the operation of the backlight unit 100 and the display panel 20, and the power assembly 60 configured to supply power to the backlight unit 100 and the display panel 20. The control assembly 50 and the power assembly 60 may be disposed in the main body 11.

The control assembly 50 may include a control circuit configured to control an operation of the display panel 20 and the backlight unit 100. The control circuit may process image data received from an external content source, transmit image data to the display panel 20, and transmit dimming data to the backlight unit 100.

The power assembly 60 may supply power to the display panel 20 and the backlight unit 100 to allow the backlight unit 100 to emit light and the display panel 20 to block or transmit light from the backlight unit 100.

The control assembly 50 and the power assembly 60 may be implemented as a printed circuit board and various circuits mounted on the printed circuit board. For example, the power circuit may include a capacitor, a coil, a resistance element, a processor, and a power circuit board on which the capacitor, the coil, the resistance element, and the processor are mounted. Further, the control circuit may include a memory, a processor, and a control circuit board on which the memory and the processor are mounted.

The display apparatus 1 may include a display case provided to support various components of the main body 11 of the display apparatus 1. In other words, various components of the main body 11 may be accommodated inside the display case. The display case may form the external appearance of the display apparatus 1.

For example, the display case may support the display panel 20. For example, the display case may support the backlight unit 100. For example, the display case may support the control assembly 50. For example, the display case may support the power assembly 60.

For example, the display apparatus 1 may include the bottom chassis 15. The bottom chassis 15 may cover the rear of the display panel 20. The bottom chassis 15 may be coupled to the rear of the top chassis 13. The bottom chassis 15 may support various components of the display apparatus 1, such as the backlight unit 100, the control assembly 50, and the power assembly 60.

The bottom chassis 15 may be formed to have a substantially flat plate shape, but is not limited thereto. The bottom chassis 15 may be formed of a material with high thermal conductivity to dissipate heat generated from the light source 1100 to the outside. For example, the bottom chassis 15 may be formed of a metal material such as aluminum or steel use stainless (SUS) steel, or a plastic material such as acrylonitrile butadiene styrene (ABS).

For example, the display apparatus 1 may include the middle mold 14. The middle mold 14 may be coupled to the bottom chassis 15. For example, the middle mold 14 may be hooked and coupled and/or mounted to the bottom chassis 15. The middle mold 14 may support the display panel 20 and/or the backlight unit 100. The middle mold 14 may form a frame of the display apparatus. For example, the middle mold 14 may be disposed on the frame of the bottom chassis 15 to support and fix at least some components of the backlight unit 100.

For example, the display apparatus 1 may include the rear cover 16. The rear cover 16 may be disposed at the rear of the bottom chassis 15 and provided to cover the bottom chassis 15 and various components mounted on the rear of the bottom chassis 15 (for example, the control assembly 50, the power assembly 60, and the like).

The configuration of the display apparatus 1 described above with reference to FIG. 2 is only an example for describing the display apparatus according to the present disclosure, and the present disclosure is not limited thereto.

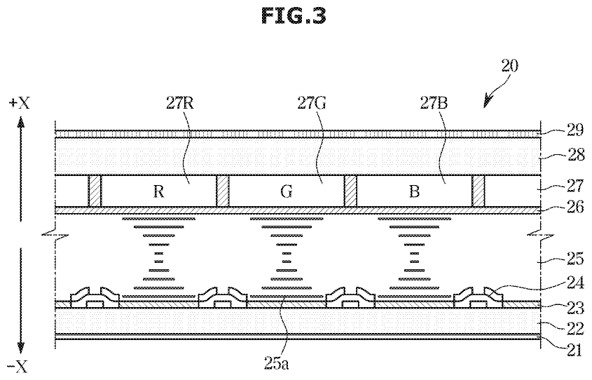

FIG. 3 is a cross-sectional view of a display panel of the display apparatus according to an embodiment of the present disclosure.

Referring to FIG. 3, the display panel 20 included in the display apparatus 1 according to an embodiment of the present disclosure may be composed of a liquid crystal display (LCD) panel, and configured to block or transmit light emitted from the backlight unit 100. The image I may be formed in front of the display panel 20 by an operation in which the display panel 20 blocks or transmits the light emitted from the backlight unit 100.

The front surface of the display panel 20 may form the screen 12 of the display apparatus 1 described above, and the plurality of pixels P may be provided in the display panel 20. In the display panel 20, the plurality of pixels P may independently block or transmit light of the backlight unit 100, and the light transmitted through the plurality of pixels P may form the image I displayed on the screen 12.

For example, as shown in FIG. 3, the display panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the thin film transistor 24, the liquid crystal layer 25, the common electrode 26, and the color filter 27. The first and second transparent substrates 22 and 28 may be formed of tempered glass or transparent resin.

The first polarizing film 21 and the second polarizing film 29 may be provided on the outside of the first and second transparent substrates 22 and 28.

Each of the first polarizing film 21 and the second polarizing film 29 may transmit a specific light beam and block other light beams. For example, the first polarizing film 21 may transmit a light beam having a magnetic field vibrating in a first direction and block other light beams. In addition, the second polarizing film 29 may transmit a light beam having a magnetic field vibrating in a second direction and block other light beams. In this case, the first direction and the second direction may be perpendicular to each other. Accordingly, a polarization direction of the light transmitted through the first polarizing film 21 and a vibration direction of the light transmitted through the second polarizing film 29 may be perpendicular to each other. As a result, generally, light may not pass through the first polarizing film 21 and the second polarizing film 29 at the same time.

The color filter 27 may be provided on an inner side of the second transparent substrate 28.

The color filter 27 may include a red filter 27R transmitting red light, a green filter 27G transmitting green light, and a blue filter 27B transmitting blue light. The red filter 27R, the green filter 27G, and the blue filter 27B may be disposed in parallel with each other. A region, in which the color filter 27 is formed, may correspond to the pixel P described above. A region, in which the red filter 27R is formed, may correspond to the red sub-pixel P_{R}, a region, in which the green filter 27G is formed, may correspond to the green sub-pixel P_{G}, and a region, in which the blue filter 27B is formed, may correspond to the blue sub-pixel P_{B}.

The pixel electrode 23 may be provided on an inner side of the first transparent substrate 22, and the common electrode 26 may be provided on an inner side of the second transparent substrate 28.

The pixel electrode 23 and the common electrode 26 may be formed of a metal material through which electricity is conducted, and the pixel electrode 23 and the common electrode 26 may generate an electric field to change the arrangement of liquid crystal molecules 25a forming the liquid crystal layer 25 to be described below.

The pixel electrode 23 and the common electrode 26 may be formed of a transparent material, and may transmit light incident from the outside. For example, the pixel electrode 23 and the common electrode 26 may include indium tin oxide (ITO), indium zinc oxide (IZO), silver (Ag) nanowire, carbon nanotube (CNT), graphene, or poly (3,4-ethylenedioxythiophene) (PEDOT). The thin film transistor (TFT) 24 may be provided in an inner side of the second transparent substrate 28.

The TFT 24 may transmit or block a current flowing through the pixel electrode 23. For example, an electric field may be formed or removed between the pixel electrode 23 and the common electrode 26 in response to turning on (closing) or turning off (opening) the TFT 24.

The TFT 24 may be formed of poly-silicon, and may be formed by semiconductor processes, such as lithography, deposition, and ion implantation.

The liquid crystal layer 25 may be formed between the pixel electrode 23 and the common electrode 26, and the liquid crystal layer 25 may be filled with the liquid crystal molecules 25a.

Liquid crystals represent an intermediate state between a solid (crystal) and a liquid. Most of the liquid crystal materials are organic compounds, and the molecular shape is in the shape of an elongated rod, and the orientation of molecules is in an irregular state in one direction, but in a regular state in other directions. As a result, the liquid crystal has both the fluidity of the liquid and the optical anisotropy of the crystal (solid).

In addition, liquid crystals also exhibit optical properties according to changes in an electric field. For example, in the liquid crystal, the orientation of molecules forming the liquid crystal may change according to a change in an electric field. When an electric field is generated in the liquid crystal layer 25, the liquid crystal molecules 25a of the liquid crystal layer 25 may be disposed along the direction of the electric field. When the electric field is not generated in the liquid crystal layer 25, the liquid crystal molecules 25a may be disposed irregularly or disposed along an alignment layer. As a result, the optical properties of the liquid crystal layer 25 may vary depending on the presence or absence of the electric field passing through the liquid crystal layer 25.

The structure of the display panel 20 described above with reference to FIG. 3 is only an example of a structure of the display panel of the display apparatus according to the present disclosure, and the present disclosure is not limited thereto.

FIG. 4 is an enlarged view of a light source device of the display apparatus according to an embodiment of the present disclosure.

Referring to FIG. 4, the display apparatus 1 according to an embodiment of the present disclosure may include the plurality of light sources 1100 and the light source substrate 1200 on which the light sources 1100 are mounted. The plurality of light sources 1100 and the light source substrate 1200 may form the light source module 1000 of the backlight unit 100.

FIG. 4 illustrates one light source 1100 among the plurality of light sources 1100 included in the light source module 1000, and a description of a structure and function of the light source 1100 described below with reference to FIG. 4 may be commonly applied to each of the plurality of light sources 1100.

The light source 1100 may be configured to emit light. The light source 1100 may be configured to emit light toward the display panel 20. The light source 1100 may employ an element configured to emit monochromatic light (light of a specific wavelength, for example, blue light) or white light (for example, light of a mixture of red light, green light, and blue light) in various directions by receiving power. For example, the light source 111 may include a light emitting diode (LED).

The light source substrate 1200 may fix the plurality of light sources 1100 to prevent a change in the position of the light source 1100. Further, the light source substrate 1200 may be electrically connected to the light source 1100. The light source substrate 1200 may supply power, which is for the light source 1100 to emit light, to the light source 1100.

The light source substrate 1200 may fix the plurality of light sources 1100 and may be configured with synthetic resin or tempered glass or a printed circuit board (PCB) on which a conductive power supply line for supplying power to the light source 1100 is formed.

The light source 1100 may be disposed on the front surface of the light source substrate 1200. The front surface of the light source substrate 1200 may refer to one surface of the light source substrate 1200 facing the display panel 20. The light source 1100 may be mounted on the light source substrate 1200 to face forward and emit light forward.

The reflective sheet 120 may be disposed in front of the light source substrate 1200. For example, the reflective sheet 120 may be attached to the front surface of the light source substrate 1200. The reflective sheet 120 may include a plurality of through-holes 120a formed at positions corresponding to each of the plurality of light sources 1100 of the light source module 1000. As shown in FIG. 4, the light source 1100 may pass through the through-hole 120a and protrude toward the front of the reflective sheet 120. Therefore, the light source 1100 and a portion of the light source substrate 1200 may be exposed toward the front of the reflective sheet 120 through the through-hole 120a. With this configuration, the light source 1100 may emit light in front of the reflective sheet 120. The through-hole 120a may correspond to a LED hole 120a.

The reflective sheet 120 may reflect light, which is emitted from the light source 1100 toward the reflective sheet 120, toward the diffuser plate 130.

A process, in which the light emitted from the plurality of light sources 1100 or the light reflected by the reflective sheet 120 travels toward the display panel 20, is as described above.

Hereinafter a structure of the light source 1100 and the light source substrate 1200 will be described in detail.

The light source 1100 may include a light emitting diode 1101. The light emitting diode 1101 may include a P-type semiconductor and an N-type semiconductor for emitting light by recombination of holes and electrons. In addition, the light emitting diode 1101 may be provided with a pair of electrodes for supplying hole and electrons to the P-type semiconductor and the N-type semiconductor, respectively.

The light emitting diode 1101 may be configured to convert electrical energy into optical energy. The light emitting diode 1101 may emit light having a maximum intensity at a predetermined wavelength based on the supplied power. For example, the light emitting diode 1101 may emit blue light having a peak value at a wavelength indicating blue color (for example, a wavelength between 430 nm and 495 nm).

For example, a multilayer reflective structure, in which a plurality of insulation layers having different refractive indices is alternately laminated, may be provided on a front surface of the light emitting diode 1101. For example, the multilayer reflective structure may be provided with a Distributed Bragg Reflector (DBR).

For example, the light emitting diode 1101 may be directly attached to the light source substrate 1200 in a Chip On Board (COB) method. In other words, the light source 1100 may include the light emitting diode 1101 in which a light emitting diode chip or a light emitting diode die is directly attached to the light source substrate 1200 without an additional packaging.

The light source module 1000 may be manufactured in such a way that the flip-chip type light emitting diode 1101 is attached to the light source substrate 1200 in the Chip-On-Board method. Accordingly, it is possible to reduce the size of the light source 1100.

The light source substrate 1200 may include a power supply line 1230 provided to supply power to the light source 1100. The power supply line 1230 may be provided to supply an electrical signal and/or power from the control assembly 50 and/or the power assembly 60 to the light source 1100. For example, the power supply line 1230 may be provided to supply power to the flip chip type light emitting diode 1101.

For example, the light source substrate 1200 may be formed by alternately laminating an insulation layer that is non-conductive and a conduction layer that is conductive.

A line or pattern, through which power and/or electrical signals pass, may be formed on the conduction layer of the light source substrate 1200. The conduction layer may be formed of various materials having an electrical conductivity. For example, the conduction layer may be formed of various metal materials, such as copper (Cu), tin (Sn), aluminum (Al), or an alloy thereof. The power supply line 1230 may be implemented by the line or pattern formed on the conduction layer of the light source substrate 1200.

A dielectric of the insulation layer of the light source substrate 1200 may insulate between lines or patterns of the conduction layer. The insulation layer may be formed of a dielectric for electrical insulation, such as FR-4.

For example, a protection layer provided to prevent or suppress damages caused by an external impact and/or damages caused by a chemical action (for example, corrosion, and the like) and/or damages caused by an optical action, to the light source substrate 1200 may be formed on an outer surface of the light source substrate 1200. For example, the protection layer of the light source substrate 1200 may include a photo solder resist (PSR).

The power supply line 1230 may be covered by the protection layer of the light source substrate 1200, so as to be prevented from being exposed to the outside.

For example, the light source substrate 1200 may include a power supply pad 1240 provided to be electrically connected to the power supply line 1230 to supply power to the flip chip type light emitting diode 1101. The power supply line 1230 may be electrically connected to the light emitting diode 1101 through the power supply pad 1240.

For example, a window may be formed in the protection layer of the light source substrate 1200 to expose a portion of the power supply line 1230 to the outside. The power supply pad 1240 may be electrically connected to a portion of the power supply line 1230 exposed to the outside of the light source substrate 1200.

For example, various electrically conductive adhesive materials such as solder and electrically conductive epoxy adhesives may be applied between the electrode of the light emitting diode 1101 and the power supply pad 1240.

The light source 1100 may include an optical dome 1102. The optical dome 1102 may cover the light emitting diode 1101. The optical dome 1102 may prevent or suppress damages to the light emitting diode 1101 caused by an external mechanical action and/or damage to the light emitting diode 1101 caused by a chemical action.

The optical dome 1102 may have a dome shape formed in such a way that a sphere is cut into a surface not including the center thereof, or may have a hemispherical shape in such a way that a sphere is cut into a surface including the center thereof. A vertical cross section of the optical dome 1102 may be a bow shape or a semicircle shape.

The optical dome 1102 may be formed of silicone or epoxy resin. For example, the molten silicon or epoxy resin may be discharged onto the light emitting diode 1101 through a nozzle, and the discharged silicon or epoxy resin may be cured, thereby forming the optical dome 1102.

The optical dome 1102 may be optically transparent or translucent. Light emitted from the light emitting diode 1101 may be emitted to the outside by passing through the optical dome 1102.

In this case, the dome-shaped optical dome 1102 may refract light like a lens. For example, light emitted from the light emitting diode 1101 may be refracted by the optical dome 1102 and thus may be dispersed.

The structure of the light source module 1000 such as the light source 1100 and the light source substrate 1200 described with reference to FIG. 4 is only an example of the structure of the light source module of the display apparatus according to the present disclosure and the present disclosure is not limited thereto.

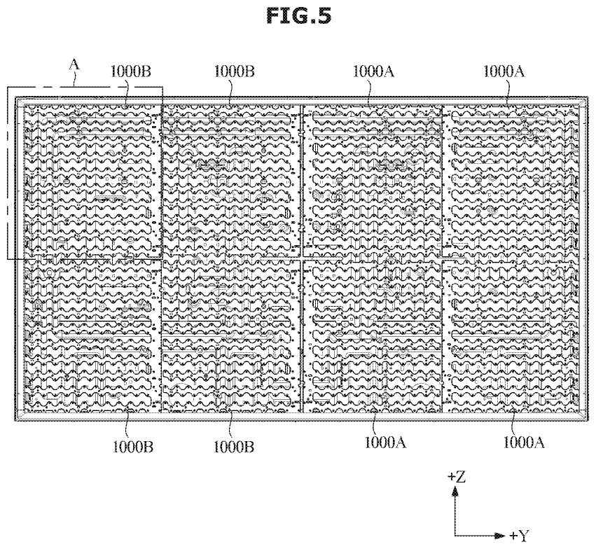

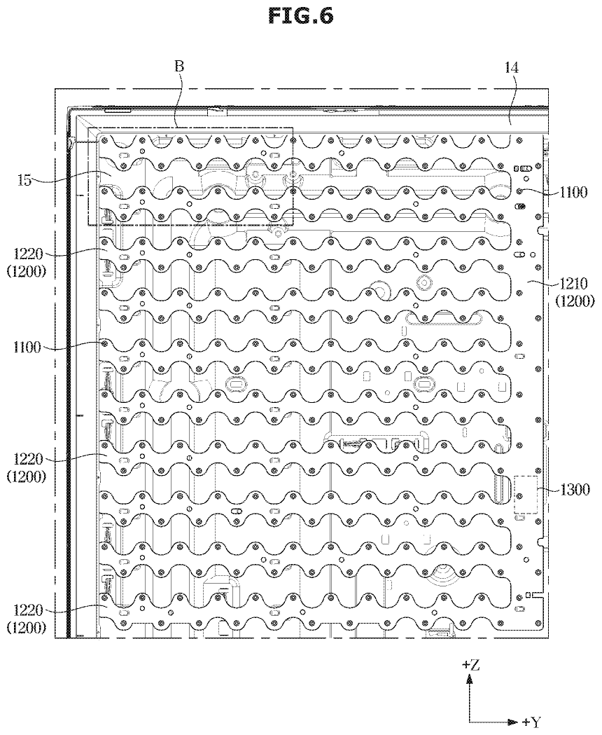

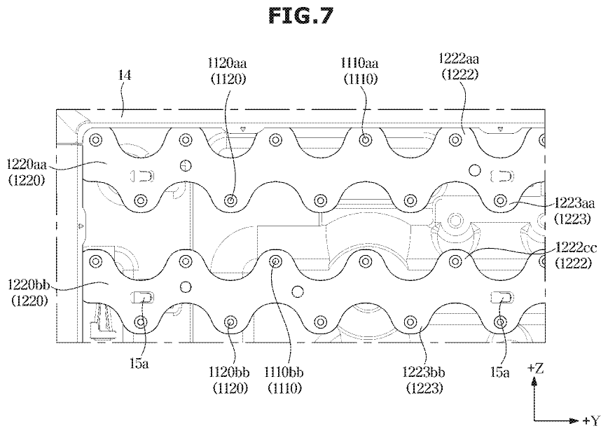

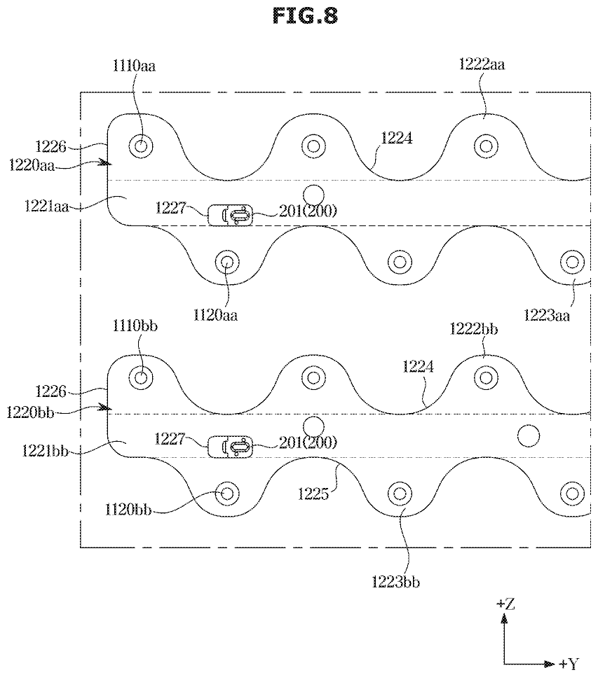

FIG. 5 is a view illustrating a light source substrate and a bottom chassis of the display apparatus according to an embodiment of the present disclosure. FIG. 6 is an enlarged view of the display apparatus according to an embodiment of the present disclosure. FIG. 7 is an enlarged view of a portion of the light source substrate and the bottom chassis of the display apparatus according to an embodiment of the present disclosure. FIG. 8 is an enlarged view of a portion of the light source substrate of the display apparatus according to an embodiment of the present disclosure.

FIG. 6 is an enlarged view of a portion A of the display apparatus shown in FIG. 5. FIG. 7 is an enlarged view of a portion B of the display apparatus shown in FIG. 6. FIG. 8 is a view illustrating a state in which the bottom chassis is omitted from the display apparatus of FIG. 7.

Referring to FIGS. 5, 6, 7, and 8, the display apparatus 1 according to an embodiment of the present disclosure may include a plurality of light source modules 1000.

The plurality of light source modules 1000 may be disposed in front of the bottom chassis 15. The plurality of light source modules 1000 may each be mounted on the bottom chassis 15. For example, the plurality of light source modules 1000 may each be fixed to the bottom chassis 15 by a fixer 201 and the middle mold 14, and may be supported by the bottom chassis 15.

For example, the plurality of light source modules 1000 may be formed in shapes that correspond to each other. In other words, each of the plurality of light source modules 1000 may have substantially the same structure.

For example, a light source module 1000A located on the right side (+Y direction side) of the display apparatus 1 among the plurality of light source modules 1000 and a light source module 1000B located on the left side (−Y direction side) of the display apparatus 1 among the plurality of light source modules 1000 may arranged to be opposite to each other with respect to the vertical and horizontal directions (that is, rotated by 180 degrees with respect to the X axis). According to this arrangement, the plurality of light source modules 1000 may be arranged to be left and right symmetrical with respect to the horizontal center of the display apparatus 1, and provided to allow both sides of luminance to be uniform with respect to the horizontal center of the display apparatus 1.

As the plurality of light source modules 1000 is designed to have almost the same shape as each other, waste of components may be prevented and efficiency of the manufacturing process may be improved, thereby reducing manufacturing cost.

However, the present disclosure is not limited thereto, and at least some of the plurality of light source modules 1000 may be formed to have different shapes.

FIG. 6 illustrates an example in which the display apparatus 1 includes multiple, such as eight or more, light source modules 1000, but the number of light source modules 1000 included in the display apparatus 1 is not limited to that shown in FIG. 6. For example, the number of light source modules 1000 included in the display apparatus 1 may be more or less than the number shown in FIG. 6. Alternatively, the display apparatus 1 may include a single light source module 1000 that is integrally formed.

Hereinafter the structure of one light source module 1000 among the plurality of light source modules 1000 will be described particularly. In an embodiment, the structure of one light source module 1000 described below may be applied to each of the plurality of light source modules 1000.

The light source module 1000 of the display apparatus 1 according to an embodiment of the present disclosure may include a plurality of substrate bars 1220.

The substrate bar 1220 may be a configuration forming at least a portion of the light source substrate 1200 described above and may be a configuration including a printed circuit board extending in one direction.

At least some of the plurality of light sources 1100 may be mounted on the plurality of substrate bars 1220, respectively. At least some of the plurality of light sources 1100 may be mounted on a front surface of the plurality of substrate bars 1220. The front surface of the plurality of substrate bars 1220 refers to one surface of the plurality of substrate bars 1220 in a direction in which the plurality of substrate bars 1220 faces the display panel 20.

The plurality of substrate bars 1220 may be composed of a printed circuit board on which the light source 1100 is mounted and the above-described power supply line 1230, and the like are provided.

The plurality of substrate bars 1220 may be arranged to be spaced apart from each other. The plurality of substrate bars 1220 may be arranged to be spaced apart from each other along one direction Z. For example, the one direction Z in which the plurality of substrate bars 1220 is spaced apart from each other may be substantially parallel to the vertical direction (for example, up and down direction) of the display apparatus 1. The plurality of substrate bars 1220 may be arranged side by side at positions spaced apart from each other. The direction in which the plurality of substrate bars 1220 is arranged may be a second direction Z or a third direction −Z.

Each of the plurality of substrate bars 1220 may be formed to have a substantially bar shape. For example, each of the plurality of substrate bars 1220 may have a width in the second direction Z or the third direction −Z, and may extend in a direction Y different from the second and third directions Z and −Z. The direction in which the plurality of substrate bars 1220 extends may be a first direction Y. For example, each of the plurality of substrate bars 1220 may have a shape in which a length in the first direction Y is longer than a width in the second direction Z or the third direction −Z.

For example, a width direction of each of the plurality of substrate bars 1220 may be substantially parallel to the vertical direction (for example, up and down direction) of the display apparatus 1. For example, a direction in which each of the plurality of substrate bars 1220 extends may be substantially parallel to the horizontal direction (for example, left and right direction) of the display apparatus 1.

For example, the direction in which each of the plurality of substrate bars 1220 extends may be parallel to the long side direction of the display apparatus 1. For example, the width direction of each of the plurality of substrate bars 1220 may be parallel to the short side direction of the display apparatus 1.

The direction in which the plurality of substrate bars 1220 is spaced apart from each other may be parallel to each width direction. In other words, the plurality of substrate bars 1220 may be arranged to be spaced apart from each other along the second direction Z, which is the width direction.

Each of the plurality of substrate bars 1220 may extend in a direction different from the direction in which the plurality of substrate bars 1220 is spaced apart from each other. Particularly, each of the plurality of substrate bars 1220 may extend in a direction (Y direction) perpendicular to the direction in which the plurality of substrate bars 1220 is spaced apart from each other (Z direction). For example, the first direction, the second direction, and the third direction described above may be directions perpendicular to each other. Additionally, the second direction and the third direction may be directions parallel to each other.

Alternatively, the direction in which the plurality of substrate bars 1220 is arranged to be spaced apart from each other and the direction in which each of the plurality of substrate bars 1220 extends may have a predetermined angle, but the angle may not be exactly vertical.

For example, the plurality of substrate bars 1220 may be arranged to allow a distance between the plurality of substrate bars 1220 in the first direction Z to be uniform. In other words, a distance in the second direction Z between a pair of adjacent substrate bars 1220 among the plurality of substrate bars 1220 may be approximately the same. Accordingly, the uniformity of luminance of the display apparatus 1 may be improved.

For example, the plurality of substrate bars 1220 may be formed to have shapes that correspond to each other. For example, the widths of the plurality of substrate bars 1220 in the second direction (Z direction) may correspond to each other. For example, the lengths of the plurality of substrate bars 1220 extending in the first direction (Y direction) may correspond to each other. For example, the plurality of substrate bars 1220 may be formed in sizes corresponding to each other.

For example, each of the plurality of substrate bars 1220 may be mounted on the bottom chassis 15. As each of the plurality of substrate bars 1220 is mounted on the bottom chassis 15 and maintains a fixed position, the plurality of light sources 1100 mounted on the plurality of substrate bars 1220 may be stably disposed at each designed position.

The reflective sheet 120 may be attached to the front surface of each of the plurality of substrate bars 1220.

The light source module 1000 of the display apparatus 1 may include a substrate body 1210. The substrate body 1210 may be a configuration forming a portion of the light source substrate 1200 described above and may be a configuration including a printed circuit board.

The plurality of substrate bars 1220 may be connected to the substrate body 1210. The plurality of substrate bars 1220 may be supported by the substrate body 1210. For example, the plurality of substrate bars 1220 may be connected to one side of the substrate body 1210.

The plurality of substrate bars 1220 may extend from the substrate body 1210. For example, each of the plurality of substrate bars 1220 may extend from the substrate body 1210 in the first direction Y. For example, each of the plurality of substrate bars 1220 may extend from one side of the substrate body 1210 in the first direction Y.

For example, the substrate body 1210 may extend along the second direction Z. For example, the substrate body 1210 may have a shape in which a length in the second direction Z is greater than a width in the first direction Y. In this case, as the substrate body 1210 extends along the direction in which the plurality of substrate bars 1220 is arranged, the substrate body 1210 may have a structure in which a greater number of substrate bars 1220 are connected. Further, in this case, as the plurality of substrate bars 1220 extends from one side, which is in the first direction Y corresponding to the width direction (that is, the relatively short direction), of the substrate body 1210, the plurality of substrate bars 1220 may have a shape that is extends longer.

For example, the substrate body 1210 may be mounted on the bottom chassis 15. Further, the substrate body 1210 may be disposed between the middle mold 14 and the bottom chassis 15 so as to be fixed to the inside of the display apparatus 1. As the substrate body 120 maintains a fixed position, the plurality of light sources 1100 mounted on the substrate body 1210 may be stably disposed at each designed position. In addition, the plurality of substrate bars 1220 connected to the substrate body 1210 may be more stably supported by the substrate body 1210.

For example, some of the plurality of light sources 1100 may be mounted on the substrate body 1210. Some of the plurality of light sources 1100 may be mounted on the front surface of the substrate body 1210. The front surface of the substrate body 1210 refers to one surface of the substrate body 1210 in the direction in which the substrate body 1210 faces the display panel 20.

The substrate body 1210 may be composed of a printed circuit board on which the light source 1100 is mounted and the power supply line 1230 described above is provided.

The reflective sheet 120 may be attached to the front surface of the substrate body 1210. For example, an integrated reflective sheet 120 may be attached to the front surface of the substrate body 1210 and the plurality of substrate bars 1220. In this case, the uniformity of luminance due to the light reflected by the reflective sheet 120 may be improved, and the process of attaching the reflective sheet 120 to the front surface of the substrate body 1210 and the plurality of substrate bars 1220 may be simplified. However, the present disclosure is not limited thereto, and the plurality of reflective sheets 120, which is distinct from each other, may be attached to the front surfaces of the substrate body 1210 and the plurality of substrate bars 1220.

The display apparatus 1 may include a connector 1300. The connector 1300 may be electrically connected to the plurality of light sources 1100. The connector 1300 may be electrically connected to the light source substrate 1200. The connector 1300 may be electrically connected to various electronic components mounted on the light source substrate 1200, such as the plurality of light sources 1100, along the power supply line 1230 provided on the light source substrate 1200. Accordingly, the connector 1300 may transmit the electrical signal transmitted from the control assembly 50 to various electronic components mounted on the light source substrate 1200, such as the plurality of light sources 1100. The connector 1300 may transmit power supplied from the power assembly 60 to various electronic components mounted on the light source substrate 1200, such as the plurality of light sources 1100. In other words, the light source module 1000 may be electrically connected to the control assembly 50 and/or the power assembly 60 through the connector 1300.

For example, the connector 1300 may be mounted on the substrate body 1210. Particularly, the connector 1300 may be mounted on a rear surface of the substrate body 1210 facing the bottom chassis 15.

As described above, the reflective sheet 120 may be attached to the front surface of the substrate body 1210, and thus when the connector 1300 is mounted on the front surface of the substrate body 1210, a portion of the reflective sheet 120, which is in a position corresponding to the mounting position of the connector 1300, may interfere with the connector 1300, and the uniformity of luminance of the display apparatus 1 may deteriorate. Alternatively, in an embodiment of the present disclosure, as the connector 1300 is mounted on the rear surface of the substrate body 1210, it is possible to prevent the reduction of the uniformity of luminance of the display apparatus 1.

For example, the substrate body 1210 and the plurality of substrate bars 1220 may be formed integrally with each other. In other words, the substrate body 1210 and the plurality of substrate bars 1220 may be connected to each other to form an integrated light source substrate 1200. The light source substrate 1200 may be composed of a printed circuit board including the substrate body 1210 and the plurality of substrate bars 1220. Alternatively, the substrate body 1210 and the plurality of substrate bars 1220 may be separate parts that are not integrally formed with each other and connected through an assembly process.

The structure of the light source module 1000, such as the substrate body 1210 and the substrate bar 1220, described above with reference to FIG. 6 is only an example, and the present disclosure is not limited thereto.

For example, each of the plurality of substrate bars 1220 may extend from the substrate body 1210 in −Y direction, or the plurality of substrate bars 1220 may extend from the substrate body 1210 in +Y direction.

In addition, it is illustrated that the substrate body 1210 extends in the vertical direction (Z direction) of the display apparatus 1, but is not limited thereto. For example, the substrate body 1210 may extend in the horizontal direction (Y direction).

In addition, it is illustrated that each of the plurality of substrate bars 1220 extends in the horizontal direction (Y direction) from one side, which is in the horizontal direction (Y direction), of the substrate body 1210, but is not limited thereto, and each of the plurality of substrate bars 1220 may extend in the vertical direction (Z direction) from one side, which is in the vertical direction (Z direction), of the substrate body 1210. In this case, the plurality of substrate bars 1220 may be arranged to be spaced apart from each other in the horizontal direction (Y direction).

In addition, unlike the above-mentioned description, a second direction that is the width direction of each of the plurality of substrate bars 1220, or a second direction in which the plurality of substrate bars 1220 is spaced apart from each other, or a second direction in which the substrate body 1210 extends or a first direction in which each of the plurality of substrate bars 1220 extends may not be parallel to either the vertical direction (Z direction) or the horizontal direction (Y direction) of the display apparatus 1.

However, hereinafter for convenience of description, the present disclosure will be described based on an embodiment in which the second direction is parallel to the vertical direction (Z direction) of the display apparatus 1, and the first direction is parallel to the horizontal direction (Y direction) of the display apparatus 1.

Hereinafter a position and structure of one of the plurality of substrate bars 1220 will be described. The structure of the substrate bar 1220 described below may be applied to correspond to the structure of each of the plurality of substrate bars 1220.

The substrate bar 1220 may be arranged between the middle mold 14 and the bottom chassis 15 in one direction. For example, some of the substrate bar 1220 may be arranged between the middle mold 14 and the bottom chassis 15 in the front and rear direction. The middle mold 14, the substrate bar 1220, and the bottom chassis 15 may be arranged sequentially along the front and rear direction.

The substrate bar 1220 may include a central extending portion 1221 extending in one direction, and protrusions 1222 and 1223 protruding from the central extending portion 1221. The central extending portion 1221 and the protrusions 1222 and 1223 may be a portion of the substrate bar 1220 and may form a portion of the light source substrate 1200.

The central extending portion 1221 may extend in the first direction (for example: Y direction and/or −Y direction). A width direction of the central extending portion 1221 may be parallel to the third direction (for example: Z direction and/or −Z direction). The central extending portion 1221 may have a shape in which an extension length in the first direction (for example: Y direction) is greater than a width in the second direction (for example: Z direction).

The central extending portion 1221 may be provided in a central portion of the substrate bar 1220. The central extending portion 1221 may include a region that passes through the center of the substrate bar 1220 and extends in the first direction (for example: Y direction).

For example, the central extending portion 1221 may include a substantially rectangular bar-shaped region.

The substrate bar 1220 may include a plurality of first protrusions 1222 protruding from one side (first side) of the central extending portion 1221. The plurality of first protrusions 1222 may protrude from one side of the central extending portion 1221 in the second direction (for example: Z direction). Each of the plurality of first protrusions 1222 may extend from the central extending portion 1221 in the second direction (for example: Z direction). For example, each of the plurality of first protrusions 1222 may extend upward from an upper side of the central extending portion 1221.

For example, the first protrusion 1222 may be connected to the central extending portion 1221 and formed integrally with each other.

The plurality of first protrusions 1222 may be arranged along the first direction (for example: Y direction). For example, the plurality of first protrusions 1222 may be arranged in such a way that positions thereof in the second direction Z (that is, a height in the vertical direction of the display apparatus 1) corresponds to each other.

For example, the plurality of first protrusions 1222 may be arranged at regular intervals along the first direction (for example: Y direction).

For example, the plurality of first protrusions 1222 may be formed to have shapes that correspond to each other. For example, a length of each of the plurality of first protrusions 1222 protruding from the central extending portion 1221 to the second direction (for example: Z direction) may correspond to each other.

Some of the plurality of light sources 1100 mounted on the substrate bar 1220 may be mounted on the plurality of first protrusions 1222. Hereinafter the light source mounted on each of the plurality of first protrusions 1222 will be referred to as ‘first side light source 1110’. For example, a single first side light source 1110 may be mounted on a single first protrusion 1222, but the present disclosure is not limited thereto. The first side light source 1110 may correspond to a first light source 1110.

The plurality of first side light sources 1110 may be disposed at positions spaced apart from the central extending portion 1221 to the second direction (Z direction). The plurality of first side light sources 1110 may be arranged to be biased upward from the central extending portion 1221.

The plurality of first side light sources 1110 may be arranged along the first direction (Y direction). For example, the plurality of first side light sources 1110 may be arranged in such a way that positions thereof in the second direction Z correspond to each other.

For example, the plurality of first side light sources 1110 may be arranged at regular intervals along the first direction (Y direction).

The substrate bar 1220 may include a plurality of second protrusions 1223. The plurality of second protrusions 1223 may protrude from the other side of the central extending portion 1221 in the second direction (Z direction). The other side of the central extending portion 1221 means the other side different from the one side of the central extending portion 1221 on which the first protrusion 1222 protrudes.

The second protrusion 1223 may extend from the central extending portion 1221 to the second direction (Z direction). For example, the plurality of second protrusions 1223 may extend downward from the lower side of the central extending portion 1221.

For example, the second protrusion 1223 may be connected to the central extending portion 1221 and formed integrally with each other.

The plurality of second protrusions 1223 may be arranged along the first direction (Y direction). For example, the plurality of second protrusions 1223 may be arranged in such a way that positions thereof in the second direction Z (for example, a height in the vertical direction of the display apparatus 1) correspond to each other.

For example, the plurality of second protrusions 1223 may be arranged at regular intervals along the first direction (Y direction).

For example, the plurality of second protrusions 1223 may be formed to have shapes that correspond to each other. For example, a length of each of the plurality of second protrusions 1223 protruding from the central extending portion 1221 to the second direction (Z direction) may correspond to each other.

Some of the plurality of light sources 1100 mounted on the substrate bar 1220 may be mounted on the plurality of second protrusions 1223. Hereinafter the light source mounted on each of the plurality of second protrusions 1223 will be referred to as ‘second side light source 1120’. For example, a single second side light source 1120 may be mounted on a single second protrusion 1223, but is not limited thereto.

The plurality of second side light sources 1120 may be disposed at positions spaced apart from the central extending portion 1221 to the second direction (Z direction). The plurality of second side light sources 1120 may be arranged to be biased downward from the central extending portion 1221.

The plurality of second side light sources 1120 may be arranged along the first direction (Y direction). For example, the plurality of second side light sources may be arranged in such a way that positions thereof in the second direction Z correspond to each other.

For example, the plurality of second side light sources 1120 may be arranged at regular intervals along the first direction (Y direction).

For example, the first side light source 1110 and the second side light source 1120 may be provided in the same numbers.

Some regions of the central extending portion 1221, in which the plurality of first protrusions 1222 protrudes, and other regions of the central extending portion 1221, in which the plurality of second protrusions 1223 extends, may intersect with respect to the first direction (Y direction). In other words, the first protrusion 1222 and the second protrusion 1223 may be arranged to intersect with each other. In a single substrate bar 1220, the plurality of first protrusions 1222 and the plurality of second protrusions 1223 may be arranged not to be parallel to each other in the first direction Z.

With this configuration, the first side light source 1110 and the second side light source 1120 may be arranged to intersect with each other along the first direction (Y direction). In a single substrate bar 1220, the plurality of light sources 1100 may be arranged in such a way that the first side light source 1110 disposed on one side in the second direction Z and the second side light source 1120 disposed on the other side are arranged to intersect with each other along the first direction (Y direction). Accordingly, the uniformity of luminance by the plurality of light sources 1100 may be improved. That is, in a single substrate bar 1220, the plurality of light sources 1100 may be arranged in a zigzag pattern. For example, the first side light source 1110 and the second side light source 1120 may be arranged in a zigzag pattern.

As the plurality of light sources 1100 is arranged as described above in each substrate bar 1220, a distance between adjacent light sources 1100 in a pair of adjacent substrate bars 1220 among the plurality of substrate bars 1220 may be reduced, and the luminance and the uniformity of luminance of the display apparatus 1 may be improved.

The substrate bar 1220 may include a plurality of first recess portions 1224. Each of the plurality of first recess portions 1224 may be formed between a pair of adjacent first protrusions 1222 among the plurality of first protrusions 1222.

The plurality of first recess portions 1224 may be provided on one side of the central extending portion 1221 in the second direction Z. For example, the plurality of first recess portions 1224 may be provided on the upper side of the central extending portion 1221.

The plurality of first recess portions 1224 may be formed to have a shape that is relatively concavely recessed toward the inside of the central extending portion 1221 in comparison with the plurality of first protrusions 1222.

The plurality of first recess portions 1224 may be arranged along the first direction (Y direction). For example, the plurality of first recess portions 1224 may be arranged in such a way that positions thereof in the second direction Z (that is, a height in the vertical direction of the display apparatus 1) correspond to each other.

For example, the plurality of first recess portions 1224 may be arranged at regular intervals along the first direction (Y direction).

For example, the plurality of first recess portions 1224 may be formed to have shapes that correspond to each other.

The substrate bar 1220 may include a plurality of second recess portions 1225. Each of the plurality of second recess portions 1225 may be formed between a pair of adjacent second protrusions 1223 among the plurality of second protrusions 1223.

The plurality of second recess portions 1225 may be provided on the other side of the central extending portion 1221 in the second direction Z. The other side of the central extending portion 1221 means the other side different from the one side of the central extending portion 1221 in which the first recess portion 1224 is provided. For example, the plurality of second recess portions 1225 may be provided on the lower side of the central extending portion 1221.

The plurality of second recess portions 1225 may be formed to have a shape that is relatively concavely recessed toward the inside of the central extending portion 1221 in comparison with the plurality of second protrusions 1223.

The plurality of second recess portions 1225 may be arranged along the first direction (Y direction). For example, the plurality of second recess portions 1225 may be arranged in such a way that positions thereof in the second direction Z (that is, a height in the vertical direction of the display apparatus 1) correspond to each other.

For example, the plurality of second recess portions 1225 may be arranged at regular intervals along the first direction (Y direction).

For example, the plurality of second recess portions 1225 may be formed to have shapes that correspond to each other.

Some regions of the central extending portion 1221, in which the plurality of first recess portions 1224 is provided, and other regions of the central extending portion 1221, in which the plurality of second recess portions 1225 is provided, may intersect with respect to the first direction (Y direction). In other words, the first recess portion 1224 and the second recess portions 1225 may be arranged to intersect with each other. In a single substrate bar 1220, the plurality of first recess portions 1224 and the plurality of second recess portions 1225 may be arranged not to be parallel to each other in the second direction Z.

For example, each of the plurality of first protrusions 1222 may be arranged side by side with the nearest second recess portion 1225 among the plurality of second recess portions 1225 in the second direction Z. For example, the plurality of first protrusions 1222 and the plurality of second recess portions 1225 may be arranged side by side in the second direction Z.

Further, each of the plurality of second protrusions 1223 may be arranged side by side with the nearest first recess portion 1224 among the plurality of first recess portions 1224 in the second direction Z. That is, the plurality of second protrusions 1223 and the plurality of first recess portions 1224 may be arranged side by side in the second direction Z.

Accordingly, the substrate bar 1220 may have an overall shape that extends in a zigzag pattern, an undulating pattern, and the like, for example.

A shape of each of the protrusions 1222 and 1223 of the substrate bar 1220 and a shape of each of the recess portion 1224 and 1225 may be different. Accordingly, the efficiency of the process for manufacturing the light source substrate 1200 may be improved. For example, in a process for manufacturing a plurality of light source substrates 1200A and 1200B from a base substrate 1200M, it may be easier to separate substrate bars 1220A and 1220B included in the different light source substrates 1200A and 1200B when the shape of each of the protrusions 1222aa and 1222bb and the shape of each of the recess portions 1224 and 1225 arranged side by side are different from each other rather than the same. Accordingly, the manufacturing cost of the product may be reduced.

In some of the plurality of substrate bars 1220, a shape from the plurality of light sources 1100 to the plurality of first protrusions 1222 may be different from a shape from the plurality of light sources 1100 to the plurality of second protrusions 1223.

For example, in some of the plurality of substrate bars 1220, shapes of edges of the plurality of first protrusions 1222 may be different from shapes of the plurality of second protrusions 1223.

In some of the plurality of substrate bars 1220, a distance d1 from the plurality of light sources 1100 to the edges (and/or borders, perimeters, outer surfaces) of the plurality of first protrusions 1222 may be different from a distance d2 from the plurality of light sources 1100 to the edges (and/or borders, perimeters, outer surfaces) of the plurality of second protrusions 1223.

The ‘edge of the first protrusion 1222’ or ‘outer surface of the first protrusion 1222’ refers to a portion of an outer edge portion of the substrate bar 1220, and means an outer edge portion of a portion of the substrate bar 1220 where the first protrusion 1222 is provided. The ‘edge of the first protrusion 1222’ may be used in a corresponding meaning with terms such as ‘outline of the first protrusion 1222’ or ‘profile of the first protrusion 1222’.

Likewise, the ‘edge of the second protrusion 1223’ or ‘outer surface of the second protrusion 1223’ refers to a portion of an outer edge portion of the substrate bar 1220, and means an outer edge portion of a portion of the substrate bar 1220 where the second protrusion 1223 is provided. The ‘edge of the second protrusion 1223’ may be used in a corresponding meaning with terms such as ‘outline of the second protrusion 1223’ or ‘profile of the second protrusion 1223’.

The distance from each of the plurality of light sources 1100 to the edge of each of the plurality of first protrusions 1222 and the distance from each of the plurality of light sources 1100 to the edge of each of the plurality of second protrusions 1223 may be different from each other in the second direction Z.

The plurality of light sources 1100 may include a first light source 1110 arranged on the first protrusion 1222 of the plurality of substrate bars 1220, and a second light source 1120 arranged on the second protrusion 1223 of the plurality of substrate bars 1220. A shape from the first light source 1110 to the edge of the first protrusion 1222 and a shape from the second light source 1120 to the edge of the second protrusion 1223 may be different.

For example, a distance in the second direction Z from the first light source 1110 to the edge of the first protrusion 1222 may be different from a distance in the second direction Z from the second light source 1120 to the edge of the second protrusion 1223. However, the present disclosure is not limited thereto, and a shape and/or distance in the second direction Z from the first light source 1110 to the edge of the first protrusion 1222 may be the same as a shape and/or distance in the second direction Z from the second light source 1120 to the edge of the second protrusion 1223.

The plurality of substrate bars 1220 may include a first substrate bar 1220aa and a second substrate bar 1220bb (refer to FIGS. 7 and 8 for example).

The first substrate bar 1220aa may include a plurality of first substrate bars 1220aa. The plurality of first substrate bars 1220aa may be arranged at a first end along the second direction and a first end along the third direction. For example, among the plurality of first substrate bars 1220aa, a first substrate bar 1220aa may be arranged at an upper end among the plurality of substrate bars 1220. In addition, among the plurality of first substrate bars 1220aa, a first substrate bar 1220aa may be arranged at a lower end among the plurality of substrate bars 1220.

The second substrate bar 1220bb may be arranged between the plurality of first substrate bars 1220aa in the vertical direction (or left and right direction). For example, the second substrate bar 1220bb may include a plurality of second substrate bars 1220bb. Accordingly, in the plurality of second substrate bars 1220bb excluding the upper first substrate bar 1220aa and the lower first substrate bar 1220aa, a distance from a first light source 1110bb to the first protrusion 1222cc may be the same as a distance from a second light source 1120bb to the second protrusion 1223bb.

In the upper first substrate bar 1220aa among the plurality of first substrate bars 1220aa, a distance from a first light source 1110aa of the first substrate bar 1220aa to an edge of the first protrusion 1222aa may be greater than a distance from a second light source 1120aa of the upper first substrate bar 1220aa to an edge of the second protrusion 1223aa. In the lower first substrate bar 1220aa among the plurality of first substrate bars 1220aa, a distance from the second light source 1120aa of the lower first substrate bar 1220aa to the edge of the second protrusion 1223aa may be greater than a distance from the first light source 1110aa of the lower first substrate bar 1220aa to the edge of the first protrusion 1222aa.

In the second substrate bar 1220bb, a distance from the first light source 1110bb of the second substrate bar 1220bb to the edge of the first protrusion 1222bb may be the same as a distance from the second light source 1120bb of the second substrate bar 1220bb to the edge of the second protrusion 1223bb.

For example, the distance from the first light source 1110aa of the upper first substrate bar 1220aa to the edge of the first protrusion 1222aa and the distance from the second light source 1120aa of the lower first substrate bar 1220aa to the edge of the second protrusion 1223aa may be greater than the distance from the first light source 1110bb of the second substrate bar 1220bb to the edge of the first protrusion 1222bb and the distance from the second light source 1120bb to the edge of the second protrusion 1223bb.

The first protrusion 1222aa of the upper first substrate bar 1220aa, on which the first light source 1110aa is arranged, may be arranged between the middle mold 14 and the bottom chassis 15. In addition, the second protrusion 1223aa of the lower first substrate bar 1220aa, on which the second light source 1120bb is arranged, may be arranged between the middle mold 14 and the bottom chassis 15.

Accordingly, because a central extending portion 1221bb of the second substrate bar 1220bb has a longer length and a wider area than a central extending portion 1221aa of the first substrate bar 1220aa, a supporter for supporting the optical member 140 may be disposed on the central extending portion 1221bb of the second substrate bar 1220bb.

Accordingly, according to the disclosure, the display apparatus 1 may not only stably fix the light source substrate 1200, but also place various components including the supporter on the light source substrate 1200.

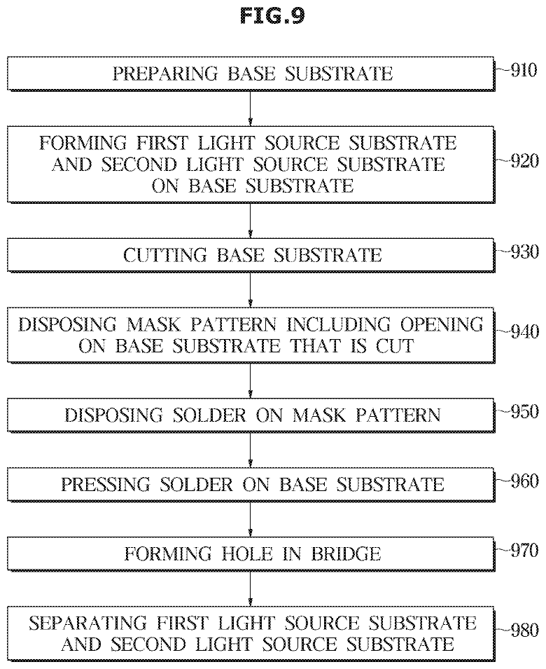

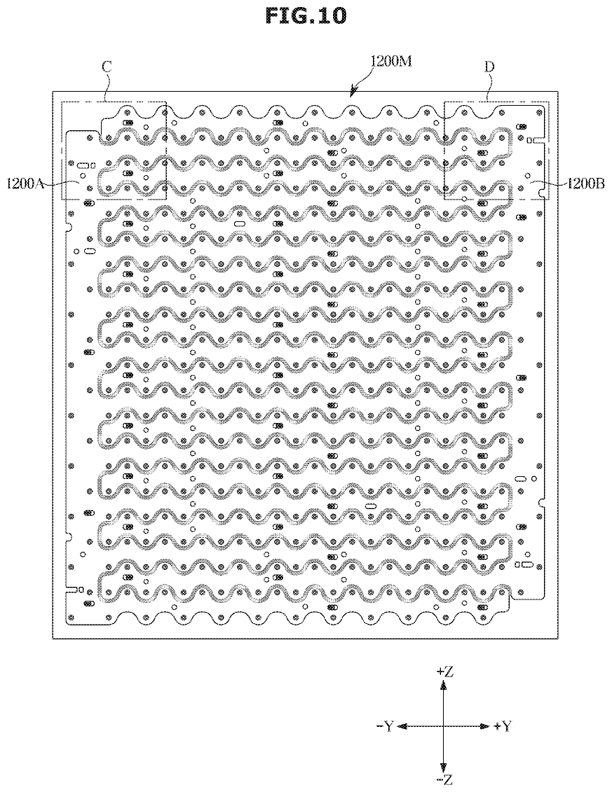

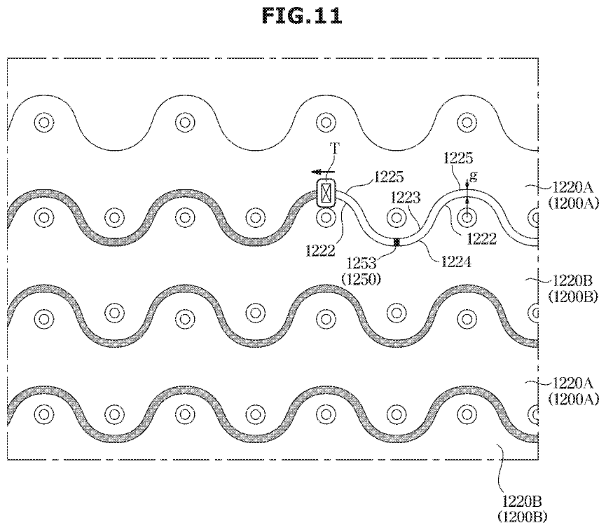

FIG. 9 is a flowchart of a method for manufacturing the light source device of the display apparatus according to an embodiment of the present disclosure. FIG. 10 is a schematic view illustrating a manufacturing process of the light source device in the display apparatus according to an embodiment of the present disclosure. FIG. 11 is a schematic view illustrating the manufacturing process of the light source device in the display apparatus according to an embodiment of the present disclosure.

FIG. 10 is a view of preparing the base substrate in the method for manufacturing the light source device according to an embodiment of the present disclosure. FIG. 11 is a view of processing the base substrate in the method for manufacturing the light source device according to an embodiment of the present disclosure.

Referring to FIGS. 9, 10, and 11, the light source substrate 1200 of the light source device 100 of the display apparatus 1 according to an embodiment of the present disclosure may be manufactured by a method of manufacturing the plurality of light source substrates 1200A and 1200B from one substrate material 1200M. One substrate material 1200M may include the base substrate 1200M.

The method for manufacturing the light source device according to an embodiment may include preparing the base substrate 1200M (step 910). In addition, the method for manufacturing the light source device according to an embodiment may include forming the first light source substrate 1200A and the second light source substrate 1200B on the base substrate 1200M (step 920). For example, the plurality of light source substrates 1200A and 1200B may be formed, illustrated, and/or designed on the base substrate 1200M. The base substrate 1200M may be provided in an integral plate shape. For example, the plurality of light source substrates 1200A and 1200B to be manufactured may be illustrated on the base substrate 1200M. For example, the plurality of light source substrates 1200A and 1200B may be a pair of light source substrates 1200A and 1200B.

The first light source substrate 1200A and the second light source substrate 1200B may be provided on the base substrate 1200M. The first light source substrate 1200A and the second light source substrate 1200B may be a plurality of light source substrates 1200A and 1200B.

The first light source substrate 1200A and the second light source substrate 1200B may include a substrate body 1210A and 1210B and a substrate bar 1220A and 1220B, respectively. For example, the first light source substrate 1200A may include a first substrate body 1210A and a first substrate bar 1220A. The second light source substrate 1200B may include a second substrate body 1210B and a second substrate bar 1220B.

The first substrate body 1210A may extend in a first direction −Z. The first substrate bar 1220A may extend from the first substrate body 1210A in a second direction Y. A plurality of first substrate bars 1220A may be provided.

The second substrate body 1210B may extend in the first direction −Z. The second substrate bar 1220B may extend from the second substrate body 1210B in a third direction −Y. For example, the second direction Y and the third direction −Y may be opposite to each other. A plurality of second substrate bars 1220B may be provided.

For example, the plurality of light source substrates 1200A and 1200B may be illustrated symmetrically at 180 degrees to each other on the base substrate 1200M. As for the plurality of light source substrates 1200A and 1200B, each of the substrate bars 1220 may be arranged alternately. Among the plurality of substrate bars 1220 provided on one light source substrate (for example, 1200A) of the plurality of light source substrates 1200A and 1200B, one of the substrate bars 1220 provided on another light source substrate (for example, 1200B) may be illustrated to be positioned between adjacent substrate bars 1220. In other words, one substrate bar 1220 provided on one of the plurality of light source substrates 1200A and 1200B and one substrate bar 1220 provided on the other may be arranged to intersect each other.

In addition, in the plurality of light source substrates 1200A and 1200B, each substrate body 1210 thereof may be disposed on opposite sides. For example, the first substrate body 1210A of the first light source substrate 1200A and the second substrate body 1210B of the second light source substrate 1200B may be positioned on opposite sides. For example, the first substrate body 1210A may be provided on the −Y side, and the second substrate body 1210B may be provided on the +Y side.

The method for manufacturing the light source device according to an embodiment may include cutting the base substrate 1200M (step 930). For example, the base substrate 1200M may be divided into the plurality of light source substrates 1200A and 1200B by cutting along the edges of the plurality of light source substrates 1200A and 1200B.

For example, a tool T that penetrates and cuts the base substrate 1200M may move along the edges of the plurality of light source substrates 1200A and 1200B and may perform a cutting process to separate the plurality of light source substrates 1200A and 1200B.

The base substrate 1200M may be cut through a routing process. For example, the tool T may be a variety of processing devices such as a router.

The tool T may define the plurality of light source substrates 1200A and 1200B by moving along a boundary between the substrate bars 1220 of each of the plurality of light source substrates 1200A and 1200B and forming a gap g between the plurality of light source substrates 1200A and 1200B. The gap g may be formed as the tool T moves along the boundary between the substrate bars 1220. The gap g may have a width approximately corresponding to a thickness of the tool T.

As the gap g is formed by the tool T, the protrusions 1222 and 1223 and the recess portions 1224 and 1225 may be formed in the plurality of substrate bars 1220A and 1220B positioned adjacently with the gap g interposed therebetween. The protrusion 1223 formed in one substrate bar 1220A and the recess portion 1224 formed in another substrate bar 1220B may face each other in the Z direction (for example, width direction) of the substrate bar 1220. In addition, the recess portion 1225 formed in one substrate bar 1220A and the protrusion 1222 formed in another substrate bar 1220B may face each other in the Z direction (for example, width direction) of the substrate bar 1220.

A difference in radius of curvature may occur between the protrusions 1222 and 1223 and the recess portions 1224 and 1225 facing each other. For example, radii of curvature of the protrusions 1222 and 1223 may be less than radii of curvature of the recess portions 1224 and 1225. The difference in the radii of curvature of the protrusions 1222 and 1223 and the recess portions 1224 and 1225 may approximately correspond to the thickness of the tool T or a thickness of the gap g.

When the radii of curvature of the protrusions 1222 and 1223 are not less than the radii of curvature of the recess portions 1224 and 1225, an additional cutting process may be required to match the designed curvature even after the tool T performs cutting by passing the boundary between the plurality of substrate bars 1220A and 1220B once. However, as in the case of an embodiment of the present disclosure, because the radii of curvature of the protrusions 1222 and 1223 are designed to be less than the radii of curvature of the recess portions 1224 and 1225, even when the tool T performs cutting by passing the boundary between the plurality of substrate bars 1220A and 1220B only once, the protrusions 1222 and 1223 and the recess portions 1224 and 1225 may be naturally formed to have the designed radius of curvature due to the thickness of the tool T.

The thickness of the tool T used in this operation may be appropriately set by considering the difference in the radii of curvature of the protrusions 1222 and 1223 and the recess portions 1224 and 1225.

Through this method, the process of separating the substrate bars 1220A and 1220B included in the plurality of light source substrates 1200A and 1200B from the base substrate 1200M may be further simplified. In addition, a portion that is unnecessarily removed during the process of manufacturing the plurality of light source substrates 1200A and 1200B from the base substrate 1200M may be reduced, and waste of materials may be prevented, thereby promoting the cost reduction. Accordingly, the manufacturing cost of the product may be reduced.

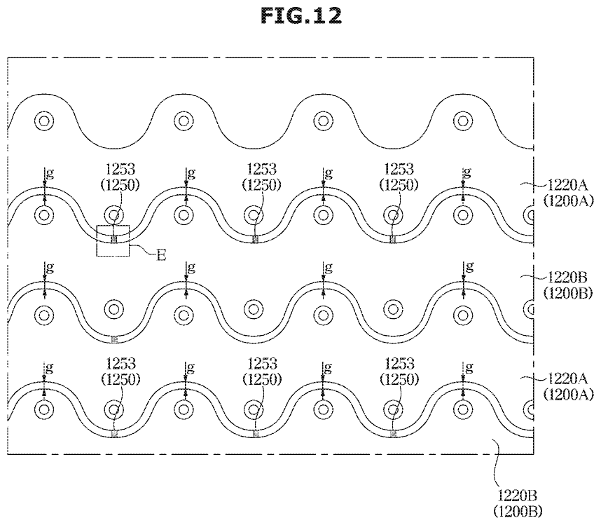

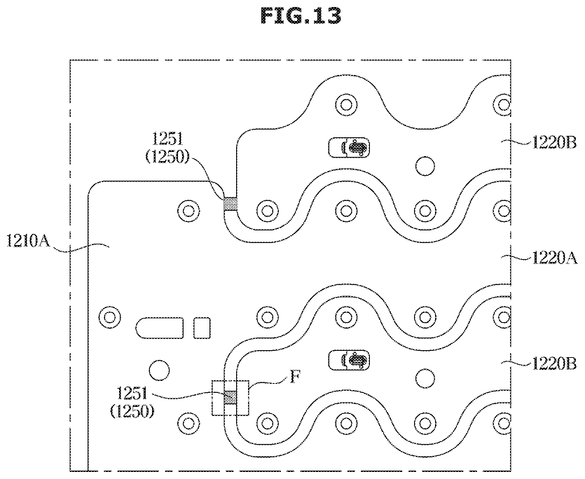

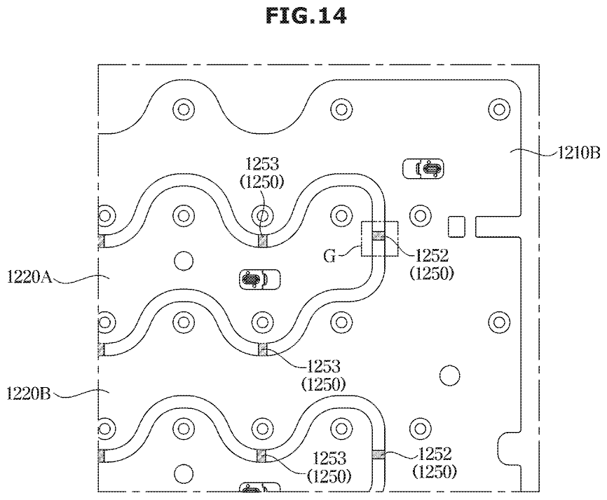

FIG. 12 is a schematic view illustrating the manufacturing process of the light source device in the display apparatus according to an embodiment of the present disclosure. FIG. 13 is a schematic view illustrating the manufacturing process of the light source device in the display apparatus according to an embodiment of the present disclosure. FIG. 14 is a schematic view illustrating the manufacturing process of the light source device in the display apparatus according to an embodiment of the present disclosure.

FIG. 12 is a view after processing the base substrate in the method for manufacturing the light source device according to an embodiment of the present disclosure. FIG. 13 is a view after processing the base substrate in the method for manufacturing the light source device according to an embodiment of the present disclosure, illustrating a state after a region C of the base substrate illustrated in FIG. 10 is processed. FIG. 14 is a view after processing the base substrate in the method for manufacturing the light source device according to an embodiment of the present disclosure, illustrating a state after a region D of the base substrate illustrated in FIG. 10 is processed.

Referring to FIGS. 9, 12, 13 and 14, in the method for manufacturing the light source device according to an embodiment, cutting the base substrate 1200M (step 930) may be cutting the base substrate 1200M so as to form a plurality of bridges 1250 connecting the first light source substrate 1200A and the second light source substrate 1200B. The bridges 1250 may include connecting ribs and connecting members.

For example, in an embodiment, the tool T may move to form the edges of the plurality of light source substrates 1200A and 1200B and cut the base substrate 1200M to allow the bridge 1250 to remain. The bridge 1250 may include a plurality of bridges 1250. The bridges 1250 may be provided to connect the plurality of light source substrates 1200A and 1200B to each other. For example, the bridges 1250 may connect the substrate bars 1220A and 1220B of each of the plurality of light source substrates 1200A and 1200B to each other. Additionally, the bridges 1250 may connect the first substrate body 1210A and the second substrate bar 1220B, and may connect the second substrate body 1210B and the first substrate bar 1220A.

For example, the bridge 1250 may connect the first substrate body 1210A and one end of the second substrate bar 1220B in the third direction −Y. Further, the bridge 1250 may connect the second substrate body 1210B and one end of the first substrate bar 1220A in the second direction Y.

The first substrate bar 1220A may include the plurality of first substrate bars 1220A, and the second substrate bar 1220B may include the plurality of second substrate bars 1220B. Each end of the plurality of first substrate bars 1220A may be connected to the second substrate body 1210B via the bridge 1250. In addition, each end of the plurality of second substrate bars 1220B may be connected to the first substrate body 1210A via the bridge 1250.

The plurality of bridges 1250 may include a first bridge 1251, a second bridge 1252, and a third bridge 1253.

The first bridge 1251 may be arranged between the first substrate body 1210A and the second substrate bar 1220B and may connect the first substrate body 1210A and the second substrate bar 1220B. The second bridge 1252 may be arranged between the second substrate body 1210B and the first substrate bar 1220A and can connect the second substrate body 1210B and the first substrate bar 1220A.

The first bridge 1251 and the second bridge 1252 may correspond. For example, the first bridge 1251 and the second bridge 1252 may be provided at positions rotated by 180 degrees from each other.

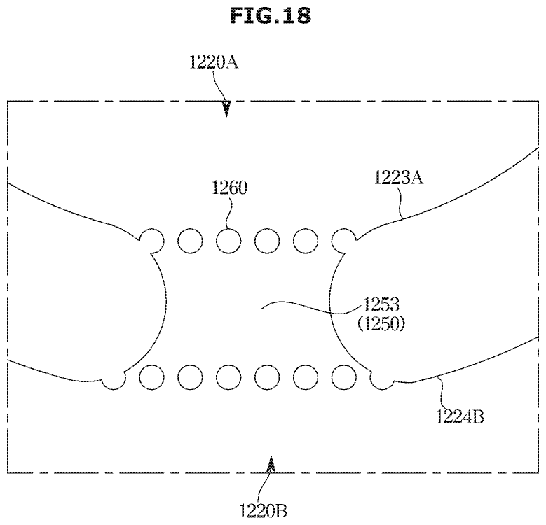

The third bridge 1253 may be arranged between the first substrate bar 1220A and the second substrate bar 1220B and may connect the first substrate bar 1220A and the second substrate bar 1220B (refer to FIG. 18).

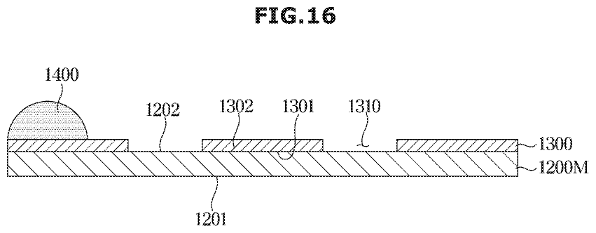

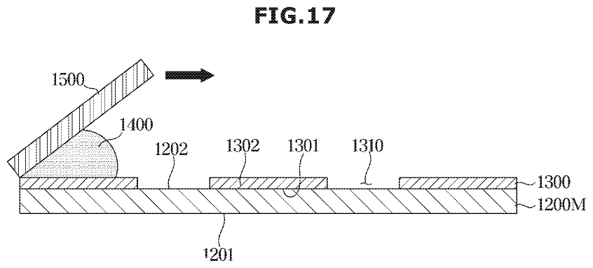

Because ends of the substrate bars 1220A and 1220B are connected to the substrate bodies 1210A and 1210B, respectively, the substrate bars 1220A and 1220B may not shake during a solder printing process of applying a solder to the base substrate 1200M described later, and the solder 1240 may be placed and/or applied at an accurate position (refer to FIGS. 16 and 17).

As the substrate bars 1220A and 1220B of each of the plurality of light source substrates 1200A and 1200B are connected by the bridge 1250, the light source substrates 1200A and 1200B may be more easily managed when storing or transporting the light source substrates 1200A and 1200B.

For example, the bridge 1250 may be provided to connect the protrusions 1222 and 1223 or the recess portions 1224 and 1225 that face each other in adjacent substrate bars 1220A and 1220B. For example, the bridge 1250 may connect edges of the protrusions 1222 and 1223, which are the shortest in a protruding direction from the central extending portion 1221 of the substrate bar 1220, and edges of portions of the recess portions 1224 and 1225 which are nearest to the central extending portion 1221 in the width direction.

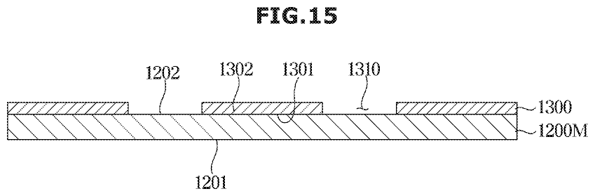

FIG. 15 is a schematic view illustrating the manufacturing process of the light source device in the display apparatus according to an embodiment of the present disclosure. FIG. 16 is a schematic view illustrating the manufacturing process of the light source device in the display apparatus according to an embodiment of the present disclosure. FIG. 17 is a schematic view illustrating the manufacturing process of the light source device in the display apparatus according to an embodiment of the present disclosure.

Referring to FIGS. 9, 15, 16, and 17, the method for manufacturing the light source device according to an embodiment may include disposing a mask pattern 1300 on the base substrate 1200M, in which the bridge 1250 is formed by being cut (step 940). The base substrate 1200M may include a first surface 1201 that is disposed on and supported by a floor or the like, and a second surface 1202 opposite to the first surface 1201. For example, the mask pattern 1300 may be disposed on the second surface 1202 of the base substrate 1200M.

The mask pattern 1300 may include a first surface 1301 and a second surface 1302 positioned opposite the first surface 1301. For example, the first surface 1301 may face downward, and the second surface 1302 may face upward. The second surface 1202 of the base substrate 1200M may be in contact with the first surface 1301 of the mask pattern 1300.

The mask pattern 1300 may include an opening 1310. The opening 1310 may be formed by penetrating the mask pattern 1300. The opening 1310 may correspond to a position where various components, such as the light source, are to be electrically connected to the base substrate 1200M. For example, the opening 1310 may be formed to correspond to a position where a solder 1400 is to be applied to the base substrate 1200M. Therefore, in response to the mask pattern 1300 and the base substrate 1200M being positioned at correct positions, the solder 1400 may be applied at an appropriate position, and various components, such as the light source, may be electrically connected to the light source substrate at an appropriate position.

The method for manufacturing the light source device according to an embodiment may include disposing the solder 1400 on the mask pattern 1300 (step 950). For example, the solder 1400 may be disposed on the second surface 1302 of the mask pattern 1300. Although the drawing illustrates that the solder 1400 is disposed on one side of the second surface 1302 of the mask pattern 1300, the location of the solder 1400 is not limited thereto, and the solder 1400 may be disposed at various locations on the second surface of the mask pattern 1300.

The method for manufacturing the light source device according to an embodiment may include pressing the solder 1400 onto the base substrate 1200M (step 960). The solder 1400 may be pressed in one direction so as to be introduced into the opening 1310. For example, the solder 1400 may be in contact with one surface of a pressing member 1500 and may be moved in one direction by the pressing member 1500, and the moved solder 1400 may flow into the opening 1310. The solder 1400 flowing into the opening 1310 may be disposed on the second surface of the base substrate 1200M.

For example, the pressing member 1500 may move the solder 1400 from the first substrate body 1210A toward the second substrate body 1210B through the first substrate bar 1220A and the second substrate bar 1220B. Further, the pressing member 1500 may move the solder 1400 from the second substrate body 1210B toward the first substrate body 1210A through the first substrate bar 1220A and the second substrate bar 1220B.

When the pressing member 1500 moves the solder 1400, a force may also be applied to the mask pattern 1300 and the base substrate 1200M. Accordingly, the base substrate 1200M may be moved slightly, and thus the opening 1310 of the mask pattern 1300 may correspond to a position different from a component mounting position of the base substrate 1200M. For example, while the substrate bars 1220B and 1220A far from the substrate bodies 1210A and 1210B are pressed, the solder 1400 may be applied to a position that does not correspond to the correct position, in which the component of the base substrate 1200M should be mounted, due to shaking.

However, according to an embodiment, one end of each of the plurality of first substrate bars 1220A may be connected to the second substrate body 1210B through the bridge 1250, and one end of each of the plurality of second substrate bars 1220B may be connected to the first substrate body 1210A through the bridge 1250. Accordingly, the solder 1400 may be prevented from being applied to a position where the component mounting positions of the base substrate 1200M do not correspond to each other.

For example, because one end of the first substrate bar 1220A adjacent to the second substrate body 1210B and the second substrate body 1210B are connected through the bridge 1250, movement of the one end of the first substrate bar 1220A adjacent to the second substrate body 1210B may be minimized. Accordingly, the solder 1400 may be applied appropriately to the component mounting position of the base substrate 1200M. In addition, because one end of the second substrate bar 1220B adjacent to the first substrate body 1210A and the first substrate body 1210A are connected through the bridge 1250, movement of the one end of the second substrate bar 1220B adjacent to the first substrate body 1210A may be minimized. Accordingly, the solder 1400 may be applied appropriately to the component mounting position of the base substrate 1200M.

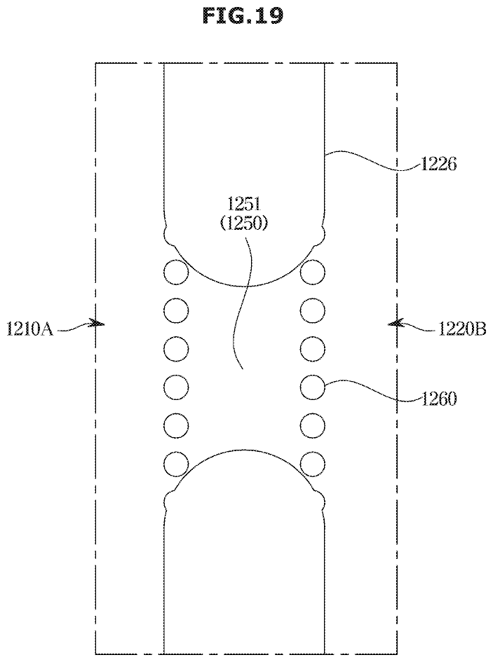

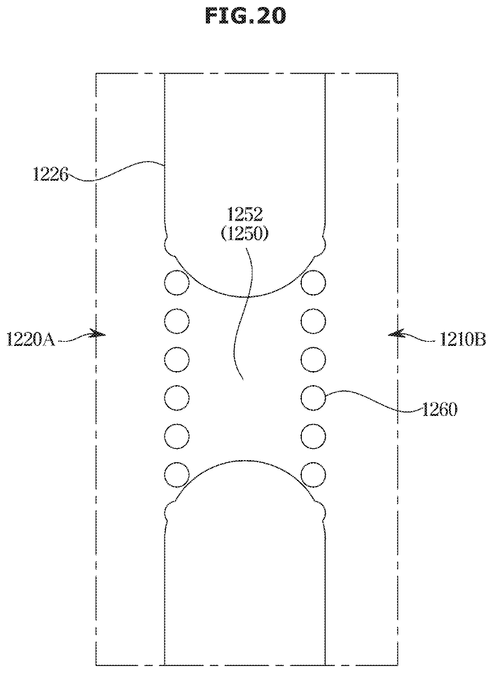

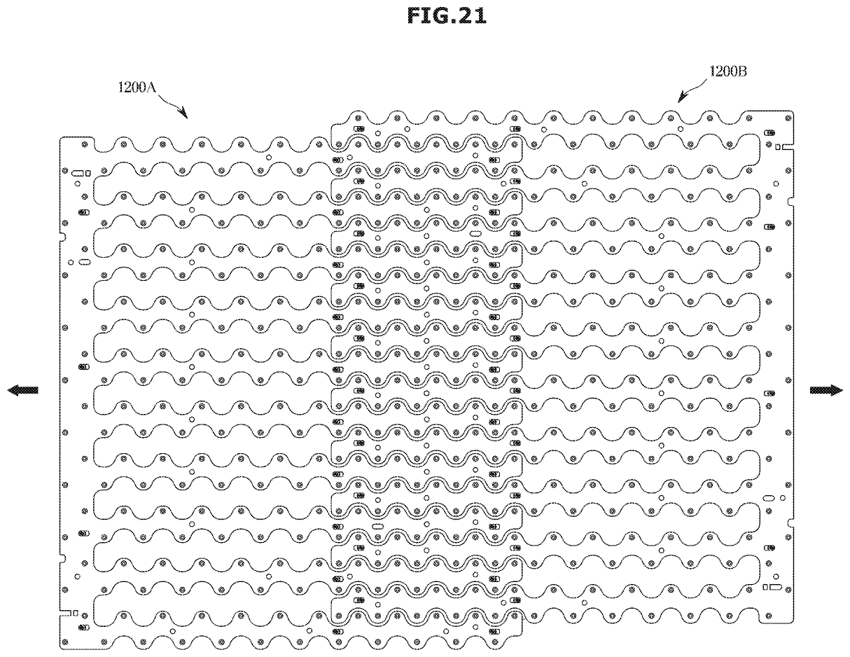

FIG. 18 is an enlarged view of a base substrate in the display apparatus according to an embodiment of the present disclosure. FIG. 19 is an enlarged view of the base substrate in the display apparatus according to an embodiment of the present disclosure. FIG. 20 is an enlarged view of the base substrate in the display apparatus according to an embodiment of the present disclosure. FIG. 21 is a schematic view illustrating the manufacturing process of the light source device in the display apparatus according to an embodiment of the present disclosure.

FIG. 18 is an enlarged view of a region E of the base substrate illustrated in FIG. 12. FIG. 19 is an enlarged view of a region F of the base substrate illustrated in FIG. 13. FIG. 20 is an enlarged view of a region G of the base substrate illustrated in FIG. 14. FIG. 21 illustrates separating the first light source substrate and the second light source substrate.

Referring to FIGS. 9, 18, 19, 20, and 21, the method for manufacturing the light source device according to an embodiment may include forming a hole in the bridge 1250 (step 970). The hole may include a guide hole 1260.

The third bridge 1253 may be provided between the first substrate bar 1220A and the second substrate bar 1220B to connect the first substrate bar 1220A and the second substrate bar 1220B. For example, the third bridge 1253 may be provided between the second protrusion 1223A of the first substrate bar 1220A and a first recess portion 1224B of the second substrate bar 1220B to connect the first substrate bar 1220A and the second substrate bar 1220B (refer to FIG. 18). However, the position of the third bridge 1253 is not limited to the above-described example. For example, the third bridge 1253 may be positioned between the recess portions 1224 and 1225 of the first substrate bar 1220A and the protrusions 1222 and 1223 of the second substrate bar 1220B to connect the first substrate bar 1220A and the second substrate bar 1220B.

For example, the guide hole 1260 may be formed in the third bridge 1253. The guide hole 1260 formed in the third bridge 1253 may be a third guide hole 1260. The third guide hole 1260 may include a plurality of third guide holes 1260. In addition, the third guide hole 1260 may be formed between the third bridge 1253 and the substrate bars 1220A and 1220B.

The first bridge 1251 may be arranged between the first substrate body 1210A and one end of the second substrate bar 1220B and may connect the first substrate body 1210A and the second substrate bar 1220B. However, the position of the first bridge 1251 is not limited to the above-described example.

In addition, the guide hole 1260 may be formed in the first bridge 1251 connecting the first substrate body 1210A and one end of the second substrate bar 1220B (refer to FIG. 19). The guide hole 1260 formed in the first bridge 1251 may be a first guide hole 1260. The first guide hole 1260 may include a plurality of first guide holes 1260. In addition, the first guide hole 1260 may be formed between the first bridge 1251 and the first substrate body 1210A and/or between the first bridge 1251 and one end 1226 of the second substrate bar 1220B in the third direction.

The second bridge 1252 may be arranged between the second substrate body 1210B and one end of the first substrate bar 1220A to connect the second substrate body 1210B and the first substrate bar 1220A. However, the position of the first bridge 1251 is not limited to the above-described example.

In addition, the guide hole 1260 may be formed in the second bridge 1252 connecting the second substrate body 1210B and one end of the first substrate bar 1220A (refer to FIG. 20). The guide hole 1260 formed in the second bridge 1252 may be a second guide hole 1260. The second bridge 1252 may correspond to the first bridge 1251 and thus the second guide hole 1260 may correspond to the first guide hole 1260. The second guide hole 1260 may include a plurality of second guide holes 1260. Additionally, the second guide hole 1260 may be formed between the second bridge 1252 and the second substrate body 1210B and/or between the second bridge 1252 and one end 1226 of the first substrate bar 1220A in the second direction.

The guide hole 1260 may be formed by drilling through the base substrate 1200M and/or the bridge. However, the method for forming the guide hole 1260 is not limited to the above-described example. The method for manufacturing the light source device according to an embodiment may further include forming a hole in the bridge 1250 and then mounting a component such as the light source on the base substrate 1200M.

When a user or a manufacturer separates the base substrate 1200M into the first light source substrate 1200A and the second light source substrate 1200B, the guide hole 1260 may guide the separation of the first light source substrate 1200A and the second light source substrate 1200B to allow the separation of the first light source substrate 1200A and the second light source substrate 1200B to be easily performed. In addition, the guide hole 1260 may allow a cut surface to be cut smoothly and may minimize generation of burrs caused by cutting. Because the burrs are reduced, it is possible to reduce defects that occur due to the burrs in the process of electrically connecting the components to the light source substrates 1200A and 1200B.

A plurality of guide holes 1260 may be provided. In the drawings, at least 12 guide holes 1260 are provided per bridge 1250, but the number of guide holes 1260 is not limited thereto.

For example, a diameter of the guide hole 1260 may be 0.1 to 0.3 mm. When the diameter of the guide hole 1260 is 0.1 to 0.3 mm, the cut surface of the substrate 1200A and 1200B may be smooth, and the occurrence of burrs due to cutting may be significantly reduced. However, the diameter of the guide hole 1260 is not limited to the above-described example.

The method for manufacturing the light source device according to an embodiment may include separating the first light source substrate 1200A and the second light source substrate 1200B (step 980).

The user and/or manufacturer can separate the plurality of light source substrates 1200A and 1200B, which is connected by the bridge 1250, by removing the bridge 1250 when necessary.

In this case, by removing the bridge 1250, the cut surface may be formed on at least some of the protrusions 1222 and 1223 or the recess portions 1224 and 1225 provided on the substrate bars 1220A and 1220B provided on the plurality of light source substrates 1200A and 1200B. The position at which the cut surfaces are formed may vary depending on the position of the bridge 1250. For example, the cut surfaces may be formed on the edges of the protrusions 1222 and 1223, which are the shortest in the protruding direction from the central extending portion 1221 of the substrate bar 1220, and the edges of the portions of the recess portions 1224 and 1225 which are nearest to the central extending portion 1221 in the width direction. According to an embodiment, the guide hole 1260 may be formed in the bridge 1250 of the base substrate 1200M. The guide hole 1260 may be formed in the bridge 1250, which connects the plurality of light source substrates, so as to allow the light source substrates to be easily separated and the cut surface to be smooth.

When the bridge 1250 is removed through the above method, the plurality of light source substrates 1200A and 1200B may be completely separated from each other as shown in FIG. 19.

Through this process, the plurality of light source substrates 1200A and 1200B may be manufactured from the base substrate 1200M, thereby preventing waste of materials and reducing manufacturing costs.

According to an embodiment, a method for manufacturing a light source device 100 including a first light source substrate 1200A and a second light source substrate 1200B each including a substrate body and a substrate bar extending from the substrate body, may include: forming the first light source substrate 1200A including a first substrate body 1210A extending in a first direction −Z and a first substrate bar 1220A extending from the first substrate body in a second direction Y in a base substrate 1200M, and forming the second light source substrate 1200B including a second substrate body 1210B extending in the first direction and a second substrate bar 1220B extending from the second substrate body in a third direction −Y opposite to the second direction so as to be disposed alternately with the first substrate bar, in the base substrate 1200M (step 920); cutting the base substrate to form a plurality of bridges 1250 connecting the first light source substrate and the second light source substrate (step 930); disposing a mask pattern 1300 including an opening 1310 on the base substrate that is cut (step 940); disposing a solder 1400 on the mask pattern (step 950); and pressing the solder on the mask pattern to allow the solder to be introduced into the opening (step 960). The cutting of the base substrate to form the plurality of bridges (step 930) may include cutting the base substrate to allow the plurality of bridges to connect the first substrate body of the first light source substrate and one end of the second substrate bar of the second light source substrate in the third direction.

The cutting of the base substrate to form the plurality of bridges (step 930) may include cutting the base substrate to allow the plurality of bridges to connect the second substrate body of the second light source substrate and one end of the first substrate bar of the first light source substrate in the second direction.

The pressing of the solder on the mask pattern to allow the solder to be introduced into the opening (step 960) may include moving a pressing member for pressing the solder in the second direction from the first substrate body toward the second substrate body.

The first substrate bar may include a plurality of first substrate bars 1220A. The second substrate bar may include a plurality of second substrate bars 1220B arranged alternately with the plurality of first substrate bars. The cutting of the base substrate to form the plurality of bridges (step 930) may include cutting the base substrate to connect each of the plurality of first substrate bars and each of the plurality of second substrate bars.

The method for manufacturing the light source device may further include forming a guide hole 1260 in the plurality of bridges 1250 (step 970).

A plurality of bridges provided between the first substrate body and the second substrate bar may include a first bridge 1251. The guide hole may include a plurality of first guide holes 1260 formed on one end of the first substrate body in the second direction and one end of the second substrate bar in the third direction in the first bridge.

The cutting of the base substrate to form the plurality of bridges (step 930) may include cutting the base substrate to allow the plurality of bridges to connect the second substrate body of the second light source substrate and one end of the first substrate bar of the first light source substrate in the second direction. The plurality of bridges provided between the second substrate body and the first substrate bar may include a second bridge 1252. The guide hole may include a plurality of second guide holes 1260 formed on one end of the second substrate body in the third direction and one end of the first substrate bar in the second direction in the second bridge.

The cutting of the base substrate to form the plurality of bridges (step 930) may include cutting the base substrate to connect the first substrate bar and the second substrate bar. The plurality of bridges provided between the first substrate bar and the second substrate bar may include a third bridge 1253. The guide hole may include a plurality of third guide holes 1260 formed on one end of the first substrate bar in the first direction and one end of the second substrate bar in a fourth direction opposite to the first direction.

The plurality of first guide holes, second guide holes, and third guide holes may each have a diameter of 0.1 to 0.3 mm per guide hole respectively.

The first substrate bar 1220A may include a central extending portion 1221 extending in the second direction, a first protrusion 1222 protruding in a fourth direction opposite to the first direction from the central extending portion to allow a light source to be mounted, and a second protrusion 1223 protruding in the first direction from the central extending portion to allow a light source to be mounted. The second substrate bar 1220B may include a central extending portion 1221 extending in the third direction, a first protrusion 1222 protruding in the fourth direction from the central extending portion to allow a light source to be mounted, and a second protrusion 1223 protruding in the first direction from the central extending portion to allow a light source to be mounted.

The first protrusion of the first substrate bar may include a plurality of first protrusions. The second protrusion of the first substrate bar may include a plurality of second protrusions. The first substrate bar may further include a plurality of first recess portions 1224 each formed between a pair of adjacent first protrusions among the plurality of first protrusions, and a plurality of second recess portions 1225 each formed between a pair of adjacent second protrusions among the plurality of second protrusions. The first protrusion of the second substrate bar may include a plurality of first protrusions, and the second protrusion of the second substrate bar may include a plurality of second protrusions. The second substrate bar may further include a plurality of first recess portions 1224 each formed between a pair of adjacent first protrusions among the plurality of first protrusions, and a plurality of second recess portions 1225 each formed between a pair of adjacent second protrusions among the plurality of second protrusions.

According to an embodiment, a method for manufacturing a light source device including a first light source substrate and a second light source substrate each including a substrate body and a substrate bar extending from the substrate body, may include: forming the first light source substrate including a first substrate body extending in a first direction and a first substrate bar extending from the first substrate body in a second direction in a base substrate, and forming the second light source substrate including a second substrate body extending in the first direction and a second substrate bar extending from the second substrate body in a third direction opposite to the second direction so as to be disposed alternately with the first substrate bar, in the base substrate (step 920); cutting the base substrate to form a plurality of bridges connecting the first light source substrate and the second light source substrate (step 930); disposing a mask pattern including an opening on the base substrate that is cut (step 940); disposing a solder on the mask pattern (step 950); pressing the solder on the mask pattern to allow the solder to be introduced into the opening (step 960); and forming a guide hole in the plurality of bridges (step 970).

The plurality of bridges provided between the first substrate body and the second substrate bar may include a first bridge 1251. The guide hole may include a plurality of first guide holes 1260 formed on one end of the first substrate body in the second direction and one end of the second substrate bar in the third direction in the first bridge.

The cutting of the base substrate to form the plurality of bridges (step 930) may include cutting the base substrate to allow the plurality of bridges to connect the second substrate body of the second light source substrate and one end of the first substrate bar of the first light source substrate in the second direction. The plurality of bridges provided between the second substrate body and the first substrate bar may include a second bridge 1252. The guide hole may include a plurality of second guide holes 1260 formed on one end of the second substrate body in the third direction and one end of the first substrate bar in the second direction in the second bridge.

The cutting of the base substrate to form the plurality of bridges (step 930) may include cutting the base substrate to connect the first substrate bar and the second substrate bar. The plurality of bridges provided between the first substrate bar and the second substrate bar may include a third bridge 1253. The guide hole may include a plurality of third guide holes 1260 formed on one end of the first substrate bar in the first direction and one end of the second substrate bar in a fourth direction opposite to the first direction in the third bridge.

The plurality of first guide holes, second guide holes, and third guide holes may have a diameter of 0.1 to 0.3 mm.

According to an embodiment, a method for manufacturing a light source device including a first light source substrate including a first substrate body extending in a first direction and a first substrate bar extending from the first substrate body in a second direction in a base substrate and a second light source substrate including a second substrate body extending in the first direction and a second substrate bar extending from the second substrate body in a third direction opposite to the second direction in the base substrate, may include: cutting the base substrate to form a plurality of bridges connecting the first substrate body and one end of the second substrate bar in the third direction and the second substrate body and one end of the first substrate bar in the second direction (step 930); disposing a mask pattern including an opening on the base substrate that is cut (step 940); disposing a solder on the mask pattern (step 950); pressing the solder on the mask pattern to allow the solder to be introduced into the opening (step 960); and forming a plurality of guide holes in each of one end of the first substrate body in the second direction and one end of the second substrate bar in the second direction among the plurality of bridges, and one end of the second substrate body in the third direction and one end of the first substrate bar in the second direction among the plurality of bridges (step 970).

The plurality of guide holes 1260 may each have a diameter of 0.1 to 0.3 mm.

The first substrate bar 1220A may include a central extending portion 1221 extending in the second direction, a first protrusion 1222 protruding in a fourth direction opposite to the first direction from the central extending portion to allow a light source to be mounted, and a second protrusion 1223 protruding in the first direction from the central extending portion to allow a light source to be mounted. The second substrate bar 1220B may include a central extending portion 1221 extending in the third direction, a first protrusion 1222 protruding in the fourth direction from the central extending portion to allow a light source to be mounted, and a second protrusion 1223 protruding in the first direction from the central extending portion to allow a light source to be mounted.

The first protrusion of the first substrate bar may include a plurality of first protrusions. The second protrusion of the first substrate bar may include a plurality of second protrusions. The first substrate bar may further include a plurality of first recess portions 1224 each formed between a pair of adjacent first protrusions among the plurality of first protrusions, and a plurality of second recess portions 1225 each formed between a pair of adjacent second protrusions among the plurality of second protrusions. The first protrusion of the second substrate bar may include a plurality of first protrusions, and the second protrusion of the second substrate bar may include a plurality of second protrusions. The second substrate bar may further include a plurality of first recess portions 1224 each formed between a pair of adjacent first protrusions among the plurality of first protrusions, and a plurality of second recess portions 1225 each formed between a pair of adjacent second protrusions among the plurality of second protrusions.

As is apparent from the above description, one end of a substrate bar far from a substrate body may be connected to another substrate body on a base substrate, and thus a light source device capable of reducing a defect rate in a process of producing the light source device, a method for manufacturing the same, and a display apparatus including the light source device may be provided.

Further, a plurality of light source substrates may be easily and neatly cut through guide holes, thereby reducing a defect rate in a process of producing a light source device, and thus the light source device capable of reducing a defect rate in a process of producing the light source device, a method for manufacturing the same, and a display apparatus including the light source device may be provided.

While the present disclosure has been particularly described with reference to exemplary embodiments, it should be understood by those of skilled in the art that various changes in form and details may be made without departing from the spirit and scope of the present disclosure.

What is claimed is:

1. A method for manufacturing a light source device comprising a first light source substrate and a second light source substrate, the method comprising:
forming, in a base substrate, the first light source substrate comprising a first substrate body, extending in a first direction, and a first substrate bar extending from the first substrate body in a second direction;
forming, in the base substrate, the second light source substrate comprising a second substrate body, extending in the first direction, and a second substrate bar extending from the second substrate body in a third direction opposite to the second direction and disposed alternately with the first substrate bar;
forming, by a cutting of the base substrate, a plurality of bridges connecting the first light source substrate and the second light source substrate, the first substrate body of the first light source substrate and one end of the second substrate bar of the second light source substrate in the third direction are connected by the plurality of bridges;
disposing, on the base substrate and after the cutting the base substrate, a mask pattern comprising an opening;
disposing a solder on the mask pattern; and
introducing, by a pressing of the solder on the mask pattern, the solder into the opening.

2. The method for manufacturing the light source device of claim 1, wherein
the second substrate body of the second light source substrate and one end of the first substrate bar of the first light source substrate in the second direction are connected by the plurality of bridges.

3. The method for manufacturing the light source device of claim 2, wherein
the pressing of the solder on the mask pattern comprises moving a pressing member in the second direction and from the first substrate body toward the second substrate body.

4. The method for manufacturing the light source device of claim 3, wherein
the first substrate bar comprises a plurality of first substrate bars,
wherein the second substrate bar comprises a plurality of second substrate bars arranged alternately with the plurality of first substrate bars, and
each of the plurality of first substrate bars and each of the plurality of second substrate bars are connected by the plurality of bridges.

5. The method for manufacturing the light source device of claim 1, further comprising:
forming guide holes in the plurality of bridges.

6. The method for manufacturing the light source device of claim 5, wherein
the plurality of bridges provided between the first substrate body and the second substrate bar comprise a first bridge,
wherein, of the guide holes, a plurality of first guide holes are arranged, in the first bridge, on the one end of the first substrate body in the second direction and on the one end of the second substrate bar in the third direction.

7. The method for manufacturing the light source device of claim 6, wherein
the plurality of bridges connect the second substrate body of the second light source substrate and the one end of the first substrate bar of the first light source substrate in the second direction,
wherein the plurality of bridges provided between the second substrate body and the first substrate bar further comprise a second bridge, and
wherein, of the guide holes, a plurality of second guide holes are arranged, in the second bridge, on the one end of the second substrate body in the third direction and on the one end of the first substrate bar in the second direction.

8. The method for manufacturing the light source device of claim 7, wherein
the plurality of bridges provided between the first substrate bar and the second substrate bar further comprise a third bridge, and
wherein, of the guide holes, a plurality of third guide holes are arranged, in the third bridge, on the one end of the first substrate bar in the first direction and on the one end of the second substrate bar in a fourth direction opposite to the first direction.

9. The method for manufacturing the light source device of claim 8, wherein
each of the plurality of first guide holes, the plurality of second guide holes, and the plurality of third guide holes comprise a diameter of 0.1 to 0.3 mm.

10. The method for manufacturing the light source device of claim 1, wherein
the first substrate bar comprises:
a first central extending portion extended in the second direction;
a first protrusion protruded in a fourth direction opposite to the first direction and from the first central extending portion; and
a second protrusion protruded in the first direction from the first central extending portion, and
wherein the second substrate bar comprises:
a second central extending portion extended in the third direction;
a third protrusion protruded in the fourth direction from the second central extending portion; and
a fourth protrusion protruded in the first direction from the second central extending portion.

11. The method for manufacturing the light source device of claim 10, wherein
the first protrusion of the first substrate bar comprises a first plurality of first protrusions,
wherein the second protrusion of the first substrate bar comprises a first plurality of second protrusions,
wherein the first substrate bar further comprises:
a plurality of first recess portions each arranged between a first pair of adjacent first protrusions among the first plurality of first protrusions; and
a plurality of second recess portions each arranged between a first pair of adjacent second protrusions among the first plurality of second protrusions,
wherein the first protrusion of the second substrate bar comprises a second plurality of first protrusions,
wherein the second protrusion of the second substrate bar comprises a second plurality of second protrusions, and
wherein the second substrate bar further comprises:
a plurality of first recess portions each arranged between a second pair of adjacent first protrusions among the second plurality of first protrusions; and
a plurality of second recess portions each arranged between a second pair of adjacent second protrusions among the second plurality of second protrusions.

12. The method for manufacturing the light source device of claim 10, further comprising mounting a light source on any of the first protrusion, the second protrusion, the third protrusion, and the fourth protrusion.
